(19) United States
(12) Patent Application Publication
(10) Pub. No.: US 2025/0286775 A1
(43) Pub. Date: Sep. 11, 2025

(54) NETWORK CONFIGURATION IDENTIFIER SIGNALLING FOR ENABLING USER EQUIPMENT-BASED BEAM PREDICTIONS

(71) Applicant: Telefonaktiebolaget LM Ericsson (PUBL), Stockholm (SE)

(72) Inventors: Henrik Rydén, STOCKHOLM (SE); Chunhui Li, Yokohama Kanagawa (JP); Jingya Li, GÖTEBORG (SE)

(21) Appl. No.: 18/859,697

(22) PCT Filed: Apr. 26, 2023
(86) PCT No.: PCT/SE2023/050387

§ 371 Date: Oct. 24, 2024

Related U.S. Application Data
(60) Provisional application No. 63/336,233, filed on Apr. 28, 2022.

(51) Int. Cl. H04L 41/0803; H04B 7/06; H04B 17/391; H04L 5/00

(52) U.S. Cl. CPC H04L 41/0803; H04B 7/06952; H04B 17/3913; H04L 5/0005

(57) ABSTRACT

A method (700) by a user equipment, UE (112), includes receiving (702), from a network node (110), at least one network configuration identifier, NW configuration ID. Based on the at least one NW configuration ID, the UE predicts (704) a channel quality for a transmission resource.

### TECHNICAL FIELD

The present disclosure relates, in general, to wireless communications and, more particularly, systems and methods for network configuration identifier signalling for enabling User Equipment-based beam predictions.

### BACKGROUND

Use of multi-antenna techniques can increase the signal quality. By spreading the total transmission power wisely over multiple antennas, an array gain can be achieved which increases the signal quality. The transmitted signal from each antenna is formed in such way that the received signal from each antenna adds up coherently at the receiver. This is referred to as beam-forming. Precoding describes how to form each antenna in the antenna array in order to form a “beam”. Use of beamforming is one cornerstone in the New Radio (NR) technology. Beams can be shaped both in horizontal and vertical domain using advanced antenna systems. For example, a UE can assess beam qualities in NR from the serving or neighboring cell via measurements on a Synchronization Signal/Physical Broadcast Channel block (SSB) or via measurement on Channel State Information-Reference Signal (CSI-RS) resources.

One of the key features of NR, compared to previous generation of wireless networks, is the ability to operate in higher frequencies (e.g., above 10 GHZ). The available large transmission bandwidths in these frequency ranges can potentially provide large data rates. However, as carrier frequency increases, both pathloss and penetration loss increase. To maintain the coverage at the same level, highly directional beams are required to focus the radio transmitter energy in a particular direction on the receiver. However, large radio antenna arrays—at both the receiver and transmitter—are needed to create such highly direction beams.

To reduce hardware costs, large antenna arrays for high frequencies use time-domain analog beamforming. The core idea of analog beamforming is to share a single radio frequency chain between many (or, potentially, all) of the antenna elements. A limitation of analog beamforming is that it is only possible to transmit radio energy using one beam (in one direction) at a given time.

The above limitation requires the network and user equipment (UE) to preform beam management procedures to establish and maintain suitable transmitter (Tx)/receiver (Rx) beam-pairs. For example, beam management procedures can be used by a Tx to sweep a geographic area by transmitting reference signals on different candidate beams, during non-overlapping time intervals, using a predetermined pattern. By measuring the quality of this reference signals at the Rx side, the best transmit and receive beams can be identified.

### NR Beam Management Procedures

Beam management procedures in NR are defined by a set of Layer 1 (L1)/Layer 2 (L2) procedures that establish and maintain a suitable beam pairs for both transmitting and receiving data [Error! Reference source not found.]. A beam management procedure can include the following sub procedures: beam determination, beam measurements, beam reporting, and beam sweeping.

In case of downlink (DL) transmission from the Network to the User Equipment (UE), P1/P2/P3 beam management procedures can be performed according to the NR SI technical report to overcome the challenges of establishing and maintaining the beam pairs when, for example, a UE moves or some blockage in the environment requires changing the beams. Although these scenarios are not directly mentioned in specifications, there are relevant procedures defined that enable the realization of these scenarios. Examples of such realizations are depicted in FIGS. 1-3.

Specifically, FIG. 1 illustrates SSB beam selection as part of an initial access procedure according to what is referred to as a P1 procedure. The P1 procedure is used to enable UE measurement on different transmission/reception point (TRP) Tx beams to support selection of TRP Tx beams/UE Rx beam(s). For example during initial access procedure, a gNodeB (gNB) transmits SSB beams in different directions to cover the whole cell. Each UE measures signal quality on corresponding SSB signals to detect and select the appropriate SSB beam. Random access is then transmitted on the Random Access Channel (RACH) resources indicated by the selected SSB. The corresponding beam will be used by both the UE and the network to communicate until connected mode beam management is active. The network infers which SSB beam was chosen by the UE without any explicit signalling.

Beamforming at a TRP typically includes an intra/inter-TRP Tx beam sweep from a set of different beams, whereas beamforming at UE typically includes a UE Rx beam sweep from a set of different beams.

FIG. 2 illustrates CSI-RS Tx beam selection in DL according to what is referred to as a P2 procedure. The P2 procedure is used to enable UE measurement on different TRP Tx beams to possibly change inter/intra-TRP Tx beam(s). The network can use the SSB beam as an indication of which (narrow) CSI-RS beams to try, i.e. the candidate set of narrow CSI-RS beams for beam management is based on the best SSB beam. Once CSI-RS is transmitted, the UE measures the Reference Signal Received Power (RSRP) and reports the result to the network. If the network receives a CSI-RSRP report from the UE where a new CSI-RS beam is better than the old used to transmit Physical Downlink Control Channel (PDCCH)/Physical Downlink Shared Channel (PDSCH), the network updates the serving beam for the UE accordingly, and possibly also modifies the candidate set of CSI-RS beams. The network can also instruct the UE to perform measurements on SSBs. If the network receives a report from the UE where a new SSB beam is better than the previous best SSB beam, a corresponding update of the candidate set of CSI-RS beams for the UE may be motivated.

The P2 procedure is performed on a possibly smaller set of beams for beam refinement than in P1. Note that P2 can be a special case of P1. For example, in connected mode gNB configures the UE with different CSI-RSs and transmits each CSI-RS on corresponding beam. UE then measures the quality of each CSI-RS beam on its current RX beam and send feedback about the quality of the measured beams. Thereafter, based on this feedback, gNB will decide and possibly indicates to the UE which beam will be used in future transmissions.

FIG. 3 illustrates UE Rx beam selection for corresponding CSI-RS Tx beam in DL according to what is referred to as a P3 procedure. The P3 procedure is used to enable UE measurement on the same TRP Tx beam to change UE Rx beam in the case UE uses beamforming. Once in connected mode, the UE is configured with a set of reference signals. Based on measurements, the UE determines which Rx beam is suitable to receive each reference signal in the set. The network then indicates which reference signals are associated with the beam that will be used to transmit PDCCH/PDSCH, and the UE uses this information to adjust its Rx beam when receiving PDCCH/PDSCH.

In connected mode, the P3 procedure can be used by the UE to find the best Rx beam for corresponding Tx beam. In this case, gNB keeps one CSI-RS Tx beam at a time, and UE performs the sweeping and measurements on its own Rx beams for that specific Tx beam. Based on the measurements, the UE then finds the best corresponding Rx beam and uses the best Rx beam for future reception when the gNB indicates the use of that Tx beam.

### Beam Measurement and Reporting in NR

For beam management, a UE can be configured to report RSRP or/and Signal Interference to Noise Ratio (SINR) for each one of up to four beams, either on CSI-RS or SSB. UE measurement reports can be sent either over Physical Uplink Control Channel (PUCCH) or Physical Uplink Shared Channel (PUSCH) to the network node, e.g., gNB.

### Reference Signal Configurations

A CSI-RS is transmitted over each Tx antenna port at the network node and for different antenna ports. The CSI-RS are multiplexed in time, frequency, and code domain such that the channel between each Tx antenna port at the network node and each receive antenna port at a UE can be measured by the UE. The time-frequency resource used for transmitting CSI-RS is referred to as a CSI-RS resource.

In NR, the CSI-RS for beam management is defined as a 1- or 2-port CSI-RS resource in a CSI-RS resource set where the filed repetition is present. The following three types of CSI-RS transmissions are supported:
Periodic CSI-RS: CSI-RS is transmitted periodically in certain slots. This CSI-RS transmission is semi-statically configured using Radio Resource Control (RRC) signaling with parameters such as CSI-RS resource, periodicity, and slot offset.
Semi-Persistent CSI-RS: Similar to periodic CSI-RS, resources for semi-persistent CSI-RS transmissions are semi-statically configured using RRC signaling with parameters such as periodicity and slot offset. However, unlike periodic CSI-RS, dynamic signaling is needed to activate and deactivate the CSI-RS transmission.
Aperiodic CSI-RS: This is a one-shot CSI-RS transmission that can happen in any slot. Here, one-shot means that CSI-RS transmission only happens once per trigger. The CSI-RS resources (i.e., the Reference Element (RE) locations that consist of subcarrier locations and Orthogonal Frequency Domain Multiplexing (OFDM) symbol locations) for aperiodic CSI-RS are semi-statically configured. The transmission of aperiodic CSI-RS is triggered by dynamic signaling through PDCCH using the CSI request field in uplink (UL) Downlink Control Information (DCI), in the same DCI where the UL resources for the measurement report are scheduled. Multiple aperiodic CSI-RS resources can be included in a CSI-RS resource set and the triggering of aperiodic CSI-RS is on a resource set basis.

In NR, an SSB consists of a pair of synchronization signals (SSs), physical broadcast channel (PBCH), and Demodulation Reference Signal (DMRS) for PBCH. A SSB is mapped to 4 consecutive OFDM symbols in the time domain and 240 contiguous subcarriers (20 Resource Blocks (RBs)) in the frequency domain.

To support beamforming and beam-sweeping for SSB transmission, in NR, a cell can transmit multiple SSBs in different narrow-beams in a time multiplexed fashion. The transmission of these SSBs is confined to a half frame time interval (5 ms). It is also possible to configure a cell to transmit multiple SSBs in a single wide-beam with multiple repetitions. The design of beamforming parameters for each of the SSBs within a half frame is up to network implementation. The SSBs within a half frame are broadcasted periodically from each cell. The periodicity of the half frames with SS/PBCH blocks is referred to as SSB periodicity, which is indicated by SIB1.

The maximum number of SSBs within a half frame, denoted by L, depends on the frequency band, and the time locations for these L candidate SSBs within a half frame depends on the SCS of the SSBs. The L candidate SSBs within a half frame are indexed in an ascending order in time from 0 to L−1. By successfully detecting PBCH and its associated DMRS, a UE knows the SSB index. A cell does not necessarily transmit SS/PBCH blocks in all L candidate locations in a half frame, and the resource of the un-used candidate positions can be used for the transmission of data or control signaling instead. It is up to network implementation to decide which candidate 20 time locations to select for SSB transmission within a half frame, and which beam to use for each SSB transmission.

### Measurement Resource Configurations

In NR, a UE can be configured with N≥1 CSI reporting settings (i.e. CSI-ReportConfig), M≥1 resource settings (i.e. CSI-ResourceConfig), where each CSI reporting setting is linked to one or more resource setting for channel and/or interference measurement. The CSI framework is modular. This means that several CSI reporting settings may be associated with the same Resource Setting.

The measurement resource configurations for beam management are provided to the UE by RRC Information Elements (IEs) CSI-ResourceConfigs. One CSI-ResourceConfig contains several NZP-CSI-RS-ResourceSets and/or CSI-SSB-ResourceSets.

A UE can be configured to perform measurement on CSI-RSs. Here the RRC IE NZP-CSI-RS-ResourceSet is used. A NZP CSI-RS resource set contains the configuration of Ks≥1 CSI-RS resources, where the configuration of each CSI-RS resource includes at least: mapping to REs, the number of antenna ports, time-domain behavior, etc. Up to 64 CSI-RS resources can be grouped to a NZP-CSI-RS-ResourceSet. A UE can also be configured to perform measurements on SSBs. Here, the RRC IE CSI-SSB-ResourceSet is used. Resource sets comprising SSB resources are defined in a similar manner.

In the case of aperiodic CSI-RS and/or aperiodic CSI reporting, the network node configures the UE with S_{c} CSI triggering states. Each triggering state contains the aperiodic CSI report setting to be triggered along with the associated aperiodic CSI-RS resource sets.

Periodic and semi-persistent Resource Settings can only comprise a single resource set (i.e., S=1) while S>=1 for aperiodic Resource Settings. This is because in the aperiodic case, one out of the S resource sets comprised in the Resource Setting is indicated by the aperiodic triggering state that triggers a CSI report.

### Measurement Reporting

Three types of CSI reporting are supported in NR as follows:
Periodic CSI Reporting on PUCCH: CSI is reported periodically by a UE. Parameters such as periodicity and slot offset are configured semi-statically by higher layer RRC signaling from the network node to the UE
Semi-Persistent CSI Reporting on PUSCH or PUCCH: Similar to periodic CSI reporting, semi-persistent CSI reporting has a periodicity and slot offset that may be semi-statically configured. However, a dynamic trigger from network node to UE may be needed to allow the UE to begin semi-persistent CSI reporting. A dynamic trigger from network node to UE is needed to request the UE to stop the semi-persistent CSI reporting.
Aperiodic CSI Reporting on PUSCH: This type of CSI reporting involves a single-shot (i.e., one time) CSI report by a UE. The single-shot CSI report is dynamically triggered by the network node using DCI. Some of the parameters related to the configuration of the aperiodic CSI report is semi-statically configured by RRC but the triggering is dynamic.

In each CSI reporting setting, the content and time-domain behavior of the report is defined, along with the linkage to the associated Resource Settings. The CSI-ReportConfig IE comprise the following configurations:
reportConfigType
   Defines the time-domain behavior, i.e. periodic CSI reporting, semi-persistent CSI reporting, or aperiodic CSI reporting, along with the periodicity and slot offset of the report for periodic CSI reporting.
reportQuantity
   Defines the reported CSI parameter(s) (i.e. the CSI content), such as Precoder Matrix Indicator (PMI), Channel Quality Indicator (CQI), Rank Indicator (RI), layer indicator (LI), CSI-RS resource index (CRI), and L1-RSRP. Only a certain number of combinations are possible (e.g., ‘cri-RI-PMI-CQI’ is one possible value and ‘cri-RSRP’ is another) and each value of reportQuantity could be said to correspond to a certain CSI mode.
codebookConfig
   Defines the codebook used for PMI reporting, along with possible codebook subset restriction (CBSR). Two “Types” of PMI codebook are defined in NR, Type I CSI and Type II CSI, each codebook type further has two variants each.
reportFrequencyConfiguration
   Define the frequency granularity of PMI and CQI (wideband or subband), if reported, along with the CSI reporting band, which is a subset of subbands of the bandwidth part (BWP) which the CSI corresponds to
Measurement restriction in time domain (ON/OFF) for channel and interference respectively

For beam management, a UE can be configured to report L1-RSRP for up to four different CSI-RS/SSB resource indicators. The reported RSRP value corresponding to the first (best) CRI/SSBRI requires 7 bits, using absolute values, while the others require 4 bits using encoding relative to the first. In NR Release 16, the report of L1-SINR for beam management has already been supported.

### Beam Prediction

An example Artificial Intelligence (AI)/Machine Learning (ML) model currently being discussed for Release 18 includes predicting the channel with respect to a beam for a certain time-frequency resource. The expected performance of such predictor depends on different aspects such as, for example, time/frequency variation of the channel due to UE mobility or changes in the environment. Due to the inherent correlation in time, frequency and the spatial domain of the channel, an AI/ML-model can be trained to exploit such correlations. The spatial domain can comprise of different beams, where the correlation properties partly depend on the how the gNB antennas forms the different beams, and how the UE forms the receiver beams.

The device can use such a prediction AI/ML-model to reduce its measurements related to beamforming. In NR, one can request a device to measure on a set of SSB beams or/and CSI-RS beams. A stationary device typically experiences less variations in beam quality in comparison to a moving device. The stationary device can, therefore, save battery and reduce the number of beam measurements by instead using an AI/ML model to predict the beam quality without an explicit measurement. It can do this, for example, by measuring a subset of the beams and predicting the rest of the beams. According to an example, with use of AI, one can measure on a subset of beams in order to predict the best beam, which can reduce up to 75% measurement time. See, https://www.3gpp.org/ftp/tsg_ran/TSG_RAN/TSGR_90e/Docs/RP-202650.zip.

There currently exist certain challenge(s), however. For example, the increased intelligence at the device can enable improved overall network performance. The intelligence needs to be trained in an efficient way such as, for example by only collecting relevant data for training the AI/ML model. The UE vendor (or UE-over-the-top training entity) might not be aware on what data it can rely on for building certain intelligence. For example, the network might change the environment (e.g., by power control or new beamforming configurations) from when the UE vendor collected the data until the same UE vendor deployed the model. Where the deployed model is expected to be working in the same environment experienced during training (e.g., certain deployment).

In particular, for beam management, the UE is not aware of what gNB configurations (e.g., precoders, power setting, etc.) are used for a certain CSI-RS resource. Thus, a potential solution that aims at predicting/forecasting instead of measuring a certain CSI-RS resource might not be feasible to implement.

As another example, the UE is not aware of what static configurations in the current beam management framework (i.e., what configurations such as, for example, precoders, are used for a certain SSB, or CSI-RS resource) that the UE can assume to be the same over time in order to build an AI/ML-model predicting information associated to such resources.

### SUMMARY

Certain aspects of the disclosure and their embodiments may provide solutions to these or other challenges. For example, methods and systems are provided for extending the beam management framework with assistance information comprising a network configuration identifier (NW configuration ID), enabling the devices to build an AI/ML-model capable of predicting the effective channel for a time-frequency resource with respect to a certain NW configuration ID.

According to certain embodiments, a method by a UE includes receiving, from a network node, at least one NW configuration ID. Based on the at least one NW configuration ID, the UE predicts a channel quality for a transmission resource.

According to certain embodiments, a UE is adapted to receive, from a network node, at least one NW configuration ID. The UE is further adapted to predict a channel quality for a transmission resource based on the at least one NW configuration ID.

According to certain embodiments, a method by a network node includes transmitting, to a UE, at least one NW configuration ID for predicting, by the UE, a channel quality for a transmission resource.

According to certain embodiments, a network node is adapted to transmit, to a UE, at least one NW configuration ID for predicting, by the UE, a channel quality for a transmission resource.

Certain embodiments may provide one or more technical advantages. For example, certain embodiments may provide a technical advantage of enabling the UE to build intelligence associated to a certain NW configuration ID. This would enable the UE to predict the effective channel associated to such NW configuration ID since all aspects regarding the NW configuration impacting the channel is assumed to be identical to a previous transmission using the same NW configuration ID. The predictions associated to the NW configuration ID may, according to certain embodiments, reduce the overhead in terms of beam management, where the reduction in overhead can lead to less UE energy being expended, improved latency in finding the best beam, and reduced NW time-frequency resources spent on finding the optimal beam.

As another example, certain embodiments may provide a technical advantage of not revealing any sensitive network information related to, for example, antenna configuration or base station positions. In a particular embodiment, the assistance information only provides the UE with a unique NW configuration ID that is based on such sensitive network information. For example, the network can encode such information before signaling it to the UE. The encoding also enables compressing the information into an identifier, which reduces signaling overhead.

As still another example, certain embodiments may provide a technical advantage of requiring less standardization overhead. The network can include any new beneficial information to the NW configuration ID related to a radio network parameter when it gets available without any standard changes. For example, a network node might be upgraded to a better antenna panel. Thus, certain embodiments may reduce the need of standardization efforts on specifying semantics for a certain radio-network parameter.

Other advantages may be readily apparent to one having skill in the art. Certain embodiments may have none, some, or all of the recited advantages.

### BRIEF DESCRIPTION OF THE DRAWINGS

For a more complete understanding of the disclosed embodiments and their features and advantages, reference is now made to the following description, taken in conjunction with the accompanying drawings, in which:

FIG. 1 illustrates SSB beam selection as part of an initial access procedure according to the P1 Procedure scenario;

FIG. 2 illustrates CSI-RS Tx beam selection in DL according to the P2 Procedure scenario;

FIG. 3 illustrates UE Rx beam selection for corresponding CSI-RS Tx beam in DL, according to the P3 Procedure scenario;

FIG. 4 an example procedure for determining predicted signal quality with respect to a NW configuration ID, according to certain embodiments;

FIG. 5 illustrates an example communication system, according to certain embodiments;

FIG. 6 illustrates an example UE, according to certain embodiments;

FIG. 7 illustrates an example network node, according to certain embodiments;

FIG. 8 illustrates a block diagram of a host, according to certain embodiments;

FIG. 9 illustrates a virtualization environment in which functions implemented by some embodiments may be virtualized, according to certain embodiments;

FIG. 10 illustrates a host communicating via a network node with a UE over a partially wireless connection, according to certain embodiments;

FIG. 11 illustrates an example method by a UE, according to certain embodiments; and

FIG. 12 illustrates an example method by a network node, according to certain embodiments.

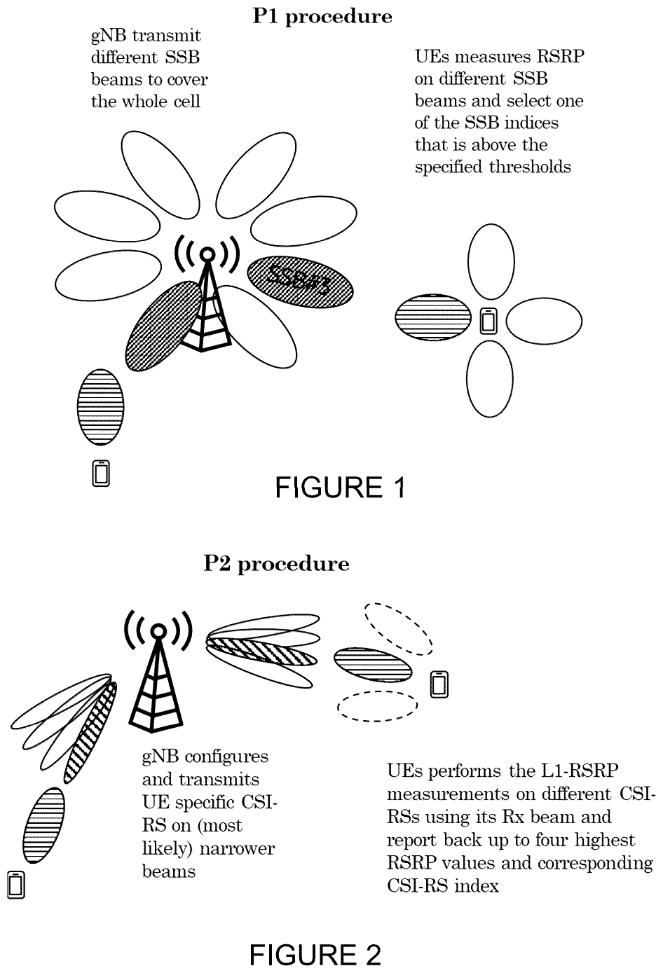

### DETAILED DESCRIPTION

Some of the embodiments contemplated herein will now be described more fully with reference to the accompanying drawings. Embodiments are provided by way of example to convey the scope of the subject matter to those skilled in the art.

As used herein, ‘node’ can be a network node or a UE. Examples of network nodes are NodeB, base station (BS), multi-standard radio (MSR) radio node such as MSR BS, eNodeB (eNB), gNodeB (gNB), Master eNB (MeNB), Secondary eNB (SeNB), integrated access backhaul (IAB) node, network controller, radio network controller (RNC), base station controller (BSC), relay, donor node controlling relay, base transceiver station (BTS), Central Unit (e.g. in a gNB), Distributed Unit (e.g. in a gNB), Baseband Unit, Centralized Baseband, C-RAN, access point (AP), transmission points, transmission nodes, Remote Radio Unit (RRU), Remote Radio Head (RRH), nodes in distributed antenna system (DAS), core network node (e.g. Mobile Switching Center (MSC), Mobility Management Entity (MME), etc.), Operations & Maintenance (O&M), Operations Support System (OSS), Self Organizing Network (SON), positioning node (e.g. E-SMLC), etc.

Another example of a node is user equipment (UE), which is a non-limiting term and refers to any type of wireless device communicating with a network node and/or with another UE in a cellular or mobile communication system. Examples of UE are target device, device to device (D2D) UE, vehicular to vehicular (V2V), machine type UE, MTC UE or UE capable of machine to machine (M2M) communication, Personal Digital Assistant (PDA), Tablet, mobile terminals, smart phone, laptop embedded equipment (LEE), laptop mounted equipment (LME), Unified Serial Bus (USB) dongles, etc.

In some embodiments, generic terminology, “radio network node” or simply “network node (NW node)”, is used. It can be any kind of network node which may comprise base station, radio base station, base transceiver station, base station controller, network controller, evolved Node B (eNB), Node B, gNodeB (gNB), relay node, access point, radio access point, Remote Radio Unit (RRU) Remote Radio Head (RRH), Central Unit (e.g. in a gNB), Distributed Unit (e.g. in a gNB), Baseband Unit, Centralized Baseband, C-RAN, access point (AP), etc.

The term radio access technology (RAT), may refer to any RAT such as, for example, Universal Terrestrial Radio Access Network (UTRA), Evolved Universal Terrestrial Radio Access Network (E-UTRA), narrow band internet of things (NB-IoT), WiFi, Bluetooth, next generation RAT, NR, 4G, 5G, etc. Any of the equipment denoted by the terms node, network node or radio network node may be capable of supporting a single or multiple RATs.

As used herein, the terms configuration ID, NW configuration ID, NW configuration, and beam ID are used interchangeably.

As used herein, the terms assistance information and network information are used interchangeably and may also be used interchangeably with and/or include configuration ID, NW configuration ID, NW configuration, and beam ID.

According to certain embodiments, methods and systems are disclosed for extending the beam management framework such that a network node provides assistance information to a wireless device. The assistance information includes a unique network configuration identifier (hereinafter called a NW configuration ID) that enables the wireless device to build an AI/ML-model capable of predicting the effective channel for a time-frequency resource with respect to a certain NW configuration ID.

According to certain embodiments, a wireless device such as a UE, for example, may receive signaling from a network and/or network node, and the signaling includes NW configuration ID. In a particular embodiment, the NW configuration ID indicates how the device effective channel, for a time-frequency resource, is impacted by a network configuration. Additionally or alternatively, the UE may determine, based on the NW configuration ID, how the device effective channel, for a time-frequency resource, is impacted by the network configuration.

In a particular embodiment, the NW configuration ID can, for example, indicate of a certain beam, pointing in a certain direction.

In a particular embodiment, the time-frequency resource can comprise a CSI-RS resource, Tracking Reference Signal (TRS) resource, or SSB resource.

In a particular embodiment, the UE may decide, based on the NW configuration ID, whether to store information associated to such identifier.

In a further particular embodiment, the UE builds an AI/ML model related to the NW configuration ID using the stored data.

In still a further particular embodiment, the UE signals AI/ML-model outputs associated with the NW configuration ID to the network/network node.

In further particular embodiment, the AI/ML-model outputs may include a prediction of a certain time-frequency resource.

According to certain embodiments, a network node such as a gNB, for example, may transmit signaling to a wireless device such as a UE, for example, and the signaling may include a unique NW configuration ID. In a particular embodiment, the NW configuration ID indicates a method in which the device effective channel, for a time-frequency resource, is impacted by a network configuration.

In a particular embodiment, the NW configuration ID can, for example, comprise of a certain beam, pointing in a certain direction.

In a particular embodiment, the time-frequency resource can comprise a CSI-RS resource, TRS resource, or SSB resource.

In a particular embodiment, the network may configure the UE to decide, based on the NW configuration ID, whether to store information associated to such identifier.

In a further particular embodiment, the network may configure the UE to build a AI/ML model related to the NW configuration ID using the stored data.

In still a further particular embodiment, the network node receives AI/ML-model outputs associated with the NW configuration ID from the UE.

In further particular embodiment, the AI/ML-model outputs may include a prediction of a certain time-frequency resource.

According to certain embodiments, the NW configuration ID can be seen as compressed information associated with the network (NW context). Such compressed information (e.g., NW configuration ID) is assumed to be used by a data-driven ML-based solution. Where such solution could use such information for training an AI/ML-model for being able to predict values associated to a certain NW configuration ID (e.g., a certain beam with a certain configured transmission power). That is, the NW information, in a compressed way, indicates the NW configurations, allowing the UE to make assumptions if seeing the same NW configuration ID in a subsequent time step. For example, the network will use the same precoder as before, enabling the UE to predict the effective channel for an CSI-RS transmission. Though embodiments are described herein in the context of beam management, the term NW configuration ID can also be seen as or interpreted as a beam ID. Thus, the terms NW configuration ID and beam ID may be used interchangeably.

The methods and techniques are first explained by an example. In the example, the UE uses the NW configuration ID to collect data and perform predictions within one RRC connection instance. Thus, the UE collects data during a first time-period and performs predictions during a second time-period. One simple method could comprise an autoregressive model:

$$X ( t ) = {b}_{0} + {b}_{1} * X ( t - 1 ) + {b}_{2} * X ( t - 2 )$$

where the UE first learns the parameters b₀, b₁, b₂, . . . by during an observation/data collection period, and uses the model to perform RSRP predictions in a subsequent time instances (x (t), x(t+1), . . . ) with respect to the NW configuration ID.

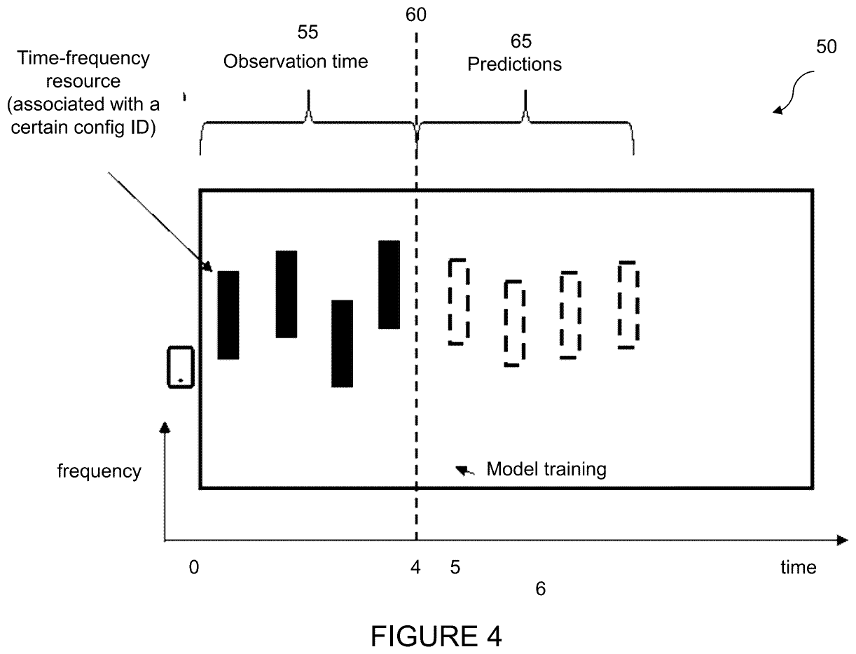

FIG. 4 illustrates a time frequency grid 50 that depicts an example procedure for determining predicted signal quality with respect to a NW configuration ID, according to certain embodiments. For example, according to certain embodiments, certain of the steps of the procedure of FIG. 4 may include:
At t=0, the wireless device (e.g., UE) connects to the network node (e.g., gNB)
The gNB configures the UE to measure on a set of time-frequency resources (e.g. one or 0more CSI-RS resources) sharing an associated NW configuration ID (for example configured with the same beam and transmission power).
During an observation time period 55, the UE trains an AI/ML model based on the observed signal quality values during the observation time t0-t3.
   In particular embodiments, the decision to start training a model can be based on one or more of:
      The observation time period 55 can be a fixed time, or the UE can, for example, estimate when it has created an accurate prediction model.
      The number of times in a given time interval for which the same UE has already been asked to perform measurements.
   The model can, for example, comprise an Augmented Reality-model of size N, where the Augmented Reality-model size can depend on the autocorrelation of the collected data
Next, at t=4 (depicted at 60 in FIG. 4), the UE provides predictions 65, which include predicted signal quality values of future time instances (t5,t6, . . . ) in relation to the NW configuration ID and a time-frequency resource. The prediction can optionally include an indication of a confidence level of the predicted signal quality estimate. The prediction can also be related to another NW configuration ID, in case multiple NW configuration IDs have been received during the observation time period 55.

### Creating a NW Configuration ID

### Node-Specific NW Configuration ID

The NW configuration ID can include information that is only valid for the UE in a current serving cell and, thus, not valid for other different cells. For example, the NW configuration ID for one cell is not valid for another (e.g., the beam shaped by one cell is not same as the beam shaped by another cell even if they share the same NW configuration ID). In one example, if a network node transmits 10 beams and each beam is configured to be strong in a certain direction, the UE can receive 10 different unique configuration IDs.

### Multi-Node NW Configuration ID

To create an NW configuration ID that is valid over multiple cells, the network can create a NW configuration ID by dividing the NW configuration information into separate elements, as shown in Table 1.

TABLE 1
NW configuration ID (N + M + K) bits

| | | |
|---|---|---|
| Hardware info | Deployment info | Beamforming info |
| (static)- N-bits | (semi-static) - M bits | K-bits |

It is noted that by dividing the NW configuration ID into elements, the UE can utilize learnings among environments that might share the same static information (e.g., same hardware), but different deployment or dynamic information. The static part can comprise of hardware information, and the dynamic part can include methods to shape a beam (e.g., precoder associated to a certain CSI-RS). The UE may, in one embodiment, request what parts of the NW configuration ID the UE wants to receive. Conversely, if the UE is capable of utilizing learnings among a multitude of environments, the UE can receive the complete NW configuration ID.

According to certain embodiments, the NW configuration ID can be based on any one or more of the following information:
Deployment information
   Antenna physical tilt
   Antenna physical direction
   Antenna Position
Hardware information
   Antenna panel
   Antenna design
   Impairment characteristics (e.g. phase noise magnitudes)
Beamforming information
   e.g. one unique ID for each potential NW beam and used transmission power

According to certain embodiments, the NW configuration ID for each beam could include information such as that shown in Table 2:

TABLE 2
NW configuration ID for in respect to
the transmission of different beams

| | | |
|---|---|---|
| Deployment-info-1 | Hardware-info-1 | Beam-ID 1 |
| Deployment-info-1 | Hardware-info-1 | Beam-ID 2 |
| . . . | | . . . |
| Deployment-info-1 | Hardware-info-1 | Beam-ID 10 |

It is noted that a second network node with the same beamforming configuration and hardware information as a first node will have a separate deployment information element. However, capable devices could utilize correlations learned for various beam-IDs from the first node, when connected to a second node by the NW configuration ID outlined herein. In this case, the UE knows that the beams are pointing in the same directions as in the first node.

### Signaling the Configuration ID (Standard Impact)

To reduce the signaling overhead, the NW configuration ID can be signaled in parts.

For the part(s) of the NW configuration ID that contains cell-specific information, such as the deployment information bits and the hardware information bits, it can be assumed that these parts of network information are rather static and may not change.

In a particular embodiment, part(s) of the NW configuration ID (e.g., deployment information bits or/and hardware information bits) is signaled to a device(s) in one or more RRC message(s). The one or more RRC message(s) can be
A cell-specific type of RRC message, e.g., a SIB message that is periodically broadcasted to all devices (e.g., SIB1); or
A RRC message that is send to device(s) during initial access procedure, e.g., Msg2 or Msg4, or MsgB; or
A UE-specific RRC message that is sent to a UE once it is connected to the network, e.g., after the network acquires the UE's capability of performing intelligent beam prediction based on the UE's capability report.

In some specific scenarios, like indoor factories, cells on wheels/wings, a new network node or transmission point may be added, a previously deployed network node or transmission point may be removed, or a mobile network node or transmission point may move to a new position. In such cases, the change of network deployment can result in an updated NW configuration ID, which can trigger the network node to send an updated NW configuration ID (e.g., the deployment information bits) to the device(s).

In a particular embodiment, part of the NW configuration ID (e.g., deployment information bits) is signaled to a device(s) in one or more MAC CE(s) or DCI(s).

The beamforming information may change more dynamically as compared to the hardware information and deployment information. Hence, it can be signaling together with or as part of the measurement RS resource configuration, as described in more detail below.

In case the size of the NW configuration ID is not large, it is also possible to signal the whole NW configuration ID together with or as part of the measurement RS resource config message.

In a particular embodiment, part of the NW configuration ID (e.g., beamforming information bits) is signaled to a device(s) as part of the measurement RS resource configuration.

In a particular embodiment, the complete NW configuration ID is signaled to a device(s) as part of the measurement RS resource configuration.

In a particular embodiment, the NW configuration ID or part of the NW configuration ID is periodically sent to a device(s), or semi-persistently sent to a device(s) upon detecting a network configuration change or upon receiving a request from the device(s), or only send to a device(s) once upon receiving a request from the device(s).

As an example, if the RS used for beam prediction is SSB, and Nis the number of actual transmitted SSBs of the gNB determined according to the parameter ssb-PositionsInBurst in SIB1, then, for each actual transmitted SSB, a NW configuration ID is provided to a UE in the SIB1. Therefore, the total number of NW configuration ID(s) contained in this message is N.

### Part of CSI-RS Resource

The NW configuration ID (or only the dynamic part of the NW configuration ID) may, for example, be introduced by extending the current measurement RS resource configuration. For example, as a part of the NZP-CSI-RS-Resource information element (IE).

An example for extending the current NZP-CSI-RS-Resource IE to support indicating the NW configuration ID, by adding a new parameter “networkConfigurationID” to 3GPP TS 38.331, is provided below. Additional text is shown in underline. A similar method can be used to signal only part of the NW configuration ID in this IE.

### NZP-CSI-RS-Resource

The IE NZP-CSI-RS-Resource is used to configure Non-Zero-Power (NZP) CSI-RS transmitted in the cell where the IE is included, which the UE may be configured to measure on (see TS 38.214 [19], clause 5.2.2.3.1). A change of configuration between periodic, semi-persistent or aperiodic for an NZP-CSI-RS-Resource is not supported without a release and add.

### NZP-CSI-RS-Resource Information Element

-- ASN1START
-- TAG-NZP-CSI-RS-RESOURCE-START

| | |
|---|---|
| NZP-CSI-RS-Resource ::= | SEQUENCE { |
| nzp-CSI-RS-ResourceId | NZP-CSI-RS-ResourceId, |

networkConfigurationID Integer(0,..,N)

| | |
|---|---|
| resourceMapping | CSI-RS-ResourceMapping, |
| powerControlOffset | INTEGER (−8..15), |
| powerControlOffsetSS | ENUMERATED{db−3, db0, |
| db3, db6} OPTIONAL, | -- Need R |
| scramblingID | ScramblingId, |
| periodicityAndOffset | CSI- |
| ResourcePeriodicityAndOffset | OPTIONAL, -- Cond |

PeriodicOrSemiPersistent

| | |
|---|---|
| qcl-InfoPeriodicCSI-RS | TCI-StateId |

OPTIONAL, -- Cond Periodic
...
}
-- TAG-NZP-CSI-RS-RESOURCE-STOP
-- ASN1STOP

NZP-CSI-RS-Resource field descriptions

periodicityAndOffset
Periodicity and slot offset sl1 corresponds to a periodicity of 1 slot, sl2 to a periodicity of two
slots, and so on. The corresponding offset is also given in number of slots (see TS 38.214
[19], clause 5.2.2.3.1). Network always configures the UE with a value for this field for
periodic and semi-persistent NZP-CSI-RS-Resource (as indicated in CSI-ResourceConfig).
powerControlOffset
Power offset of PDSCH RE to NZP CSI-RS RE. Value in dB (see TS 38.214 [19], clauses
5.2.2.3.1 and 4.1).
powerControlOffsetSS
Power offset of NZP CSI-RS RE to SSS RE. Value in dB (see TS 38.214 [19], clause
5.2.2.3.1).
qcl-InfoPeriodicCSI-RS
For a target periodic CSI-RS, contains a reference to one TCI-State in TCI-States for
providing the QCL source and QCL type. For periodic CSI-RS, the source can be SSB or
another periodic-CSI-RS. Refers to the TCI-State which has this value for tci-StateId and is
defined in tci-StatesToAddModList in the PDSCH-Config included in the BWP-Downlink
corresponding to the serving cell and to the DL BWP to which the resource belongs to (see
TS 38.214 [19], clause 5.2.2.3.1).
resourceMapping
OFDM symbol location(s) in a slot and subcarrier occupancy in a PRB of the CSI-RS
resource.
scramblingID
Scrambling ID (see TS 38.214 [19], clause 5.2.2.3.1).
NetworkConfigurationID
Unique identifier which enables predictability of the effective channel for an ML-capable
device

### UE Steps Based on Received Information

According to certain embodiments, a UE may take any combination of the following steps associated with receiving the NW configuration ID:

### Data Collection and Model Training

In a particular embodiment, the UE can start to collect data based on one or more of:
Having received a NW configuration ID from the NW
Having received a NW configuration ID in more than N CSI-RS resources.
Hardware capability of the device (e.g., available storage)
. . .

After receiving N samples, in a particular embodiment, the UE can start training a model, capable of predicting a channel associated to the network configuration ID in a time-frequency resource. Example AI/ML models to predict the future signal quality value can comprise of decision trees, random forest, feed forward neural networks, autoregressive models, or convolutional neural networks. The input for the model can comprise of feeding signal quality values associated to a certain configuration ID in t₁, . . . , tₙ into a machine learning model (e.g., Neural network), and then learn the signal quality for the same ID in tₙ₊₁, tₙ₊₂.

In a particular embodiment, the UE can also train a model that predicts different NW configuration IDs. For example, the UE may use data collected from a first ID to predict a second ID. More particularly, for example, the UE may use data collected on beam ID 1 to predict beam ID 2.

### UE Request for Additional Information (Standard Impact)

In a particular embodiment, the UE requests assistance information with respect to a certain NW configuration ID(s). For example, the assistance information may include how long the NW configuration ID has been valid or is expected to be valid. As another example, the assistance information may include or indicate the validity for each part of the NW configuration ID (dynamic/hardware/deployment part). As another example, the assistance information may include statistics relating to how often the NW configuration ID has been used. For example, in a particular embodiment, the assistance information may include a percentage of all NZP-CSI-RS or SSB transmissions.

### UE Subscription-Based Procedure

In a particular embodiment, the UE can subscribe to information with respect to a certain NW configuration ID. For example, the UE may subscribe to receive a notification when such a NW configuration ID is no longer valid.

### UE Model Inference (Performing Predictions)

In a particular embodiment, for example, the UE performs prediction for RSRP to an NZP-CSI-RS or SSB with a certain NW configuration ID. For example, the one or more predictions may correspond to a time series of predictions at time t₀, leading to [RSRP(t₀+T), RSRP(t₀+2*T), RSRP(t₀+3*T), . . . , RSRP(t₀+K*T)] as an outcome. The network can use such predictions, for example, to:
initiate inter-frequency handover;
set handover/reselection parameters;
change UE scheduler priority such as, for example, scheduling a UE when the expected signal quality is good; and/or
set link-adaptation parameters.

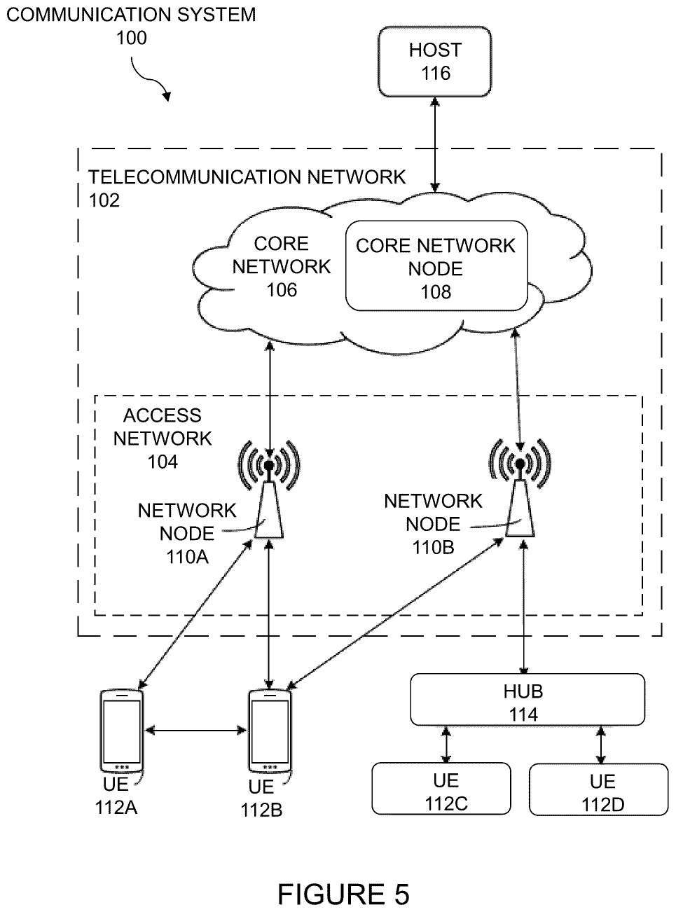

FIG. 5 shows an example of a communication system 100 in accordance with some embodiments. In the example, the communication system 100 includes a telecommunication network 102 that includes an access network 104, such as a radio access network (RAN), and a core network 106, which includes one or more core network nodes 108. The access network 104 includes one or more access network nodes, such as network nodes 110a and 110b (one or more of which may be generally referred to as network nodes 110), or any other similar 3^{rd} Generation Partnership Project (3GPP) access node or non-3GPP access point. The network nodes 110 facilitate direct or indirect connection of user equipment (UE), such as by connecting UEs 112a, 112b, 112c, and 112d (one or more of which may be generally referred to as UEs 112) to the core network 106 over one or more wireless connections.

Example wireless communications over a wireless connection include transmitting and/or receiving wireless signals using electromagnetic waves, radio waves, infrared waves, and/or other types of signals suitable for conveying information without the use of wires, cables, or other material conductors. Moreover, in different embodiments, the communication system 100 may include any number of wired or wireless networks, network nodes, UEs, and/or any other components or systems that may facilitate or participate in the communication of data and/or signals whether via wired or wireless connections. The communication system 100 may include and/or interface with any type of communication, telecommunication, data, cellular, radio network, and/or other similar type of system.

The UEs 112 may be any of a wide variety of communication devices, including wireless devices arranged, configured, and/or operable to communicate wirelessly with the network nodes 110 and other communication devices. Similarly, the network nodes 110 are arranged, capable, configured, and/or operable to communicate directly or indirectly with the UEs 112 and/or with other network nodes or equipment in the telecommunication network 102 to enable and/or provide network access, such as wireless network access, and/or to perform other functions, such as administration in the telecommunication network 102.

In the depicted example, the core network 106 connects the network nodes 110 to one or more hosts, such as host 116. These connections may be direct or indirect via one or more intermediary networks or devices. In other examples, network nodes may be directly coupled to hosts. The core network 106 includes one more core network nodes (e.g., core network node 108) that are structured with hardware and software components. Features of these components may be substantially similar to those described with respect to the UEs, network nodes, and/or hosts, such that the descriptions thereof are generally applicable to the corresponding components of the core network node 108. Example core network nodes include functions of one or more of a Mobile Switching Center (MSC), Mobility Management Entity (MME), Home Subscriber Server (HSS), Access and Mobility Management Function (AMF), Session Management Function (SMF), Authentication Server Function (AUSF), Subscription Identifier De-concealing function (SIDF), Unified Data Management (UDM), Security Edge Protection Proxy (SEPP), Network Exposure Function (NEF), and/or a User Plane Function (UPF).

The host 116 may be under the ownership or control of a service provider other than an operator or provider of the access network 104 and/or the telecommunication network 102, and may be operated by the service provider or on behalf of the service provider. The host 116 may host a variety of applications to provide one or more service. Examples of such applications include live and pre-recorded audio/video content, data collection services such as retrieving and compiling data on various ambient conditions detected by a plurality of UEs, analytics functionality, social media, functions for controlling or otherwise interacting with remote devices, functions for an alarm and surveillance center, or any other such function performed by a server.

As a whole, the communication system 100 of FIG. 5 enables connectivity between the UEs, network nodes, and hosts. In that sense, the communication system may be configured to operate according to predefined rules or procedures, such as specific standards that include, but are not limited to: Global System for Mobile Communications (GSM); Universal Mobile Telecommunications System (UMTS); Long Term Evolution (LTE), and/or other suitable 2G, 3G, 4G, 5G standards, or any applicable future generation standard (e.g., 6G); wireless local area network (WLAN) standards, such as the Institute of Electrical and Electronics Engineers (IEEE) 802.11 standards (WiFi); and/or any other appropriate wireless communication standard, such as the Worldwide Interoperability for Microwave Access (WiMax), Bluetooth, Z-Wave, Near Field Communication (NFC) ZigBee, LiFi, and/or any low-power wide-area network (LPWAN) standards such as LoRa and Sigfox.

In some examples, the telecommunication network 102 is a cellular network that implements 3GPP standardized features. Accordingly, the telecommunications network 102 may support network slicing to provide different logical networks to different devices that are connected to the telecommunication network 102. For example, the telecommunications network 102 may provide Ultra Reliable Low Latency Communication (URLLC) services to some UEs, while providing Enhanced Mobile Broadband (eMBB) services to other UEs, and/or Massive Machine Type Communication (mMTC)/Massive IoT services to yet further UEs.

In some examples, the UEs 112 are configured to transmit and/or receive information without direct human interaction. For instance, a UE may be designed to transmit information to the access network 104 on a predetermined schedule, when triggered by an internal or external event, or in response to requests from the access network 104. Additionally, a UE may be configured for operating in single- or multi-RAT or multi-standard mode. For example, a UE may operate with any one or combination of Wi-Fi, NR (New Radio) and LTE, i.e. being configured for multi-radio dual connectivity (MR-DC), such as E-UTRAN (Evolved-UMTS Terrestrial Radio Access Network) New Radio-Dual Connectivity (EN-DC).

In the example, the hub 114 communicates with the access network 104 to facilitate indirect communication between one or more UEs (e.g., UE 112c and/or 112d) and network nodes (e.g., network node 110b). In some examples, the hub 114 may be a controller, router, content source and analytics, or any of the other communication devices described herein regarding UEs. For example, the hub 114 may be a broadband router enabling access to the core network 106 for the UEs. As another example, the hub 114 may be a controller that sends commands or instructions to one or more actuators in the UEs. Commands or instructions may be received from the UEs, network nodes 110, or by executable code, script, process, or other instructions in the hub 114. As another example, the hub 114 may be a data collector that acts as temporary storage for UE data and, in some embodiments, may perform analysis or other processing of the data. As another example, the hub 114 may be a content source. For example, for a UE that is a VR headset, display, loudspeaker or other media delivery device, the hub 114 may retrieve VR assets, video, audio, or other media or data related to sensory information via a network node, which the hub 114 then provides to the UE either directly, after performing local processing, and/or after adding additional local content. In still another example, the hub 114 acts as a proxy server or orchestrator for the UEs, in particular in if one or more of the UEs are low energy IoT devices.

The hub 114 may have a constant/persistent or intermittent connection to the network node 110b. The hub 114 may also allow for a different communication scheme and/or schedule between the hub 114 and UEs (e.g., UE 112c and/or 112d), and between the hub 114 and the core network 106. In other examples, the hub 114 is connected to the core network 106 and/or one or more UEs via a wired connection. Moreover, the hub 114 may be configured to connect to an M2M service provider over the access network 104 and/or to another UE over a direct connection. In some scenarios, UEs may establish a wireless connection with the network nodes 110 while still connected via the hub 114 via a wired or wireless connection. In some embodiments, the hub 114 may be a dedicated hub—that is, a hub whose primary function is to route communications to/from the UEs from/to the network node 110b. In other embodiments, the hub 114 may be a non-dedicated hub—that is, a device which is capable of operating to route communications between the UEs and network node 110b, but which is additionally capable of operating as a communication start and/or end point for certain data channels.

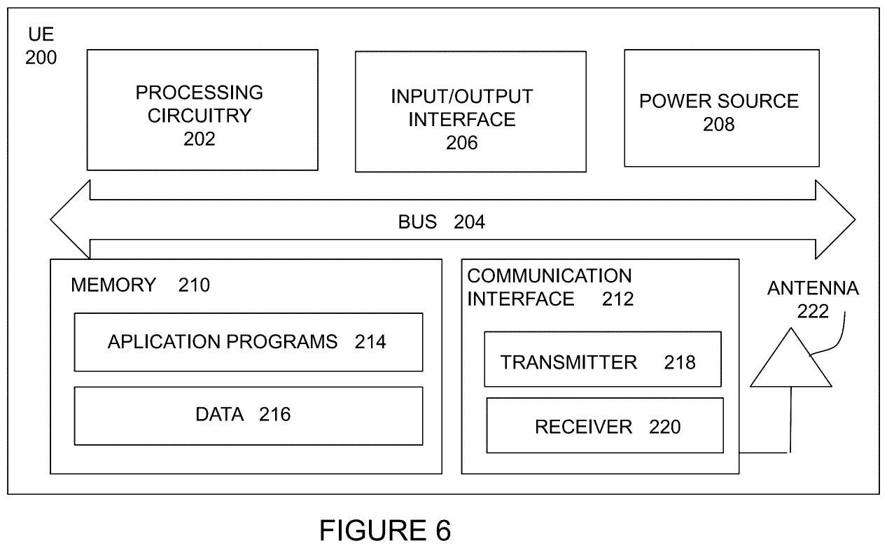

FIG. 6 shows a UE 200 in accordance with some embodiments. As used herein, a UE refers to a device capable, configured, arranged and/or operable to communicate wirelessly with network nodes and/or other UEs. Examples of a UE include, but are not limited to, a smart phone, mobile phone, cell phone, voice over IP (VOIP) phone, wireless local loop phone, desktop computer, personal digital assistant (PDA), wireless cameras, gaming console or device, music storage device, playback appliance, wearable terminal device, wireless endpoint, mobile station, tablet, laptop, laptop-embedded equipment (LEE), laptop-mounted equipment (LME), smart device, wireless customer-premise equipment (CPE), vehicle-mounted or vehicle embedded/integrated wireless device, etc. Other examples include any UE identified by the 3rd Generation Partnership Project (3GPP), including a narrow band internet of things (NB-IoT) UE, a machine type communication (MTC) UE, and/or an enhanced MTC (eMTC) UE.

A UE may support device-to-device (D2D) communication, for example by implementing a 3GPP standard for sidelink communication, Dedicated Short-Range Communication (DSRC), vehicle-to-vehicle (V2V), vehicle-to-infrastructure (V2I), or vehicle-to-everything (V2X). In other examples, a UE may not necessarily have a user in the sense of a human user who owns and/or operates the relevant device. Instead, a UE may represent a device that is intended for sale to, or operation by, a human user but which may not, or which may not initially, be associated with a specific human user (e.g., a smart sprinkler controller). Alternatively, a UE may represent a device that is not intended for sale to, or operation by, an end user but which may be associated with or operated for the benefit of a user (e.g., a smart power meter).

The UE 200 includes processing circuitry 202 that is operatively coupled via a bus 204 to an input/output interface 206, a power source 208, a memory 210, a communication interface 212, and/or any other component, or any combination thereof. Certain UEs may utilize all or a subset of the components shown in FIG. 6. The level of integration between the components may vary from one UE to another UE. Further, certain UEs may contain multiple instances of a component, such as multiple processors, memories, transceivers, transmitters, receivers, etc.

The processing circuitry 202 is configured to process instructions and data and may be configured to implement any sequential state machine operative to execute instructions stored as machine-readable computer programs in the memory 210. The processing circuitry 202 may be implemented as one or more hardware-implemented state machines (e.g., in discrete logic, field-programmable gate arrays (FPGAs), application specific integrated circuits (ASICs), etc.); programmable logic together with appropriate firmware; one or more stored computer programs, general-purpose processors, such as a microprocessor or digital signal processor (DSP), together with appropriate software; or any combination of the above. For example, the processing circuitry 202 may include multiple central processing units (CPUs).

In the example, the input/output interface 206 may be configured to provide an interface or interfaces to an input device, output device, or one or more input and/or output devices. Examples of an output device include a speaker, a sound card, a video card, a display, a monitor, a printer, an actuator, an emitter, a smartcard, another output device, or any combination thereof. An input device may allow a user to capture information into the UE 200. Examples of an input device include a touch-sensitive or presence-sensitive display, a camera (e.g., a digital camera, a digital video camera, a web camera, etc.), a microphone, a sensor, a mouse, a trackball, a directional pad, a trackpad, a scroll wheel, a smartcard, and the like. The presence-sensitive display may include a capacitive or resistive touch sensor to sense input from a user. A sensor may be, for instance, an accelerometer, a gyroscope, a tilt sensor, a force sensor, a magnetometer, an optical sensor, a proximity sensor, a biometric sensor, etc., or any combination thereof. An output device may use the same type of interface port as an input device. For example, a Universal Serial Bus (USB) port may be used to provide an input device and an output device.

In some embodiments, the power source 208 is structured as a battery or battery pack. Other types of power sources, such as an external power source (e.g., an electricity outlet), photovoltaic device, or power cell, may be used. The power source 208 may further include power circuitry for delivering power from the power source 208 itself, and/or an external power source, to the various parts of the UE 200 via input circuitry or an interface such as an electrical power cable. Delivering power may be, for example, for charging of the power source 208. Power circuitry may perform any formatting, converting, or other modification to the power from the power source 208 to make the power suitable for the respective components of the UE 200 to which power is supplied.

The memory 210 may be or be configured to include memory such as random access memory (RAM), read-only memory (ROM), programmable read-only memory (PROM), erasable programmable read-only memory (EPROM), electrically erasable programmable read-only memory (EEPROM), magnetic disks, optical disks, hard disks, removable cartridges, flash drives, and so forth. In one example, the memory 210 includes one or more application programs 214, such as an operating system, web browser application, a widget, gadget engine, or other application, and corresponding data 216. The memory 210 may store, for use by the UE 200, any of a variety of various operating systems or combinations of operating systems.

The memory 210 may be configured to include a number of physical drive units, such as redundant array of independent disks (RAID), flash memory, USB flash drive, external hard disk drive, thumb drive, pen drive, key drive, high-density digital versatile disc (HD-DVD) optical disc drive, internal hard disk drive, Blu-Ray optical disc drive, holographic digital data storage (HDDS) optical disc drive, external mini-dual in-line memory module (DIMM), synchronous dynamic random access memory (SDRAM), external micro-DIMM SDRAM, smartcard memory such as tamper resistant module in the form of a universal integrated circuit card (UICC) including one or more subscriber identity modules (SIMs), such as a USIM and/or ISIM, other memory, or any combination thereof. The UICC may for example be an embedded UICC (eUICC), integrated UICC (iUICC) or a removable UICC commonly known as ‘SIM card.’ The memory 210 may allow the UE 200 to access instructions, application programs and the like, stored on transitory or non-transitory memory media, to off-load data, or to upload data. An article of manufacture, such as one utilizing a communication system may be tangibly embodied as or in the memory 210, which may be or comprise a device-readable storage medium.

The processing circuitry 202 may be configured to communicate with an access network or other network using the communication interface 212. The communication interface 212 may comprise one or more communication subsystems and may include or be communicatively coupled to an antenna 222. The communication interface 212 may include one or more transceivers used to communicate, such as by communicating with one or more remote transceivers of another device capable of wireless communication (e.g., another UE or a network node in an access network). Each transceiver may include a transmitter 218 and/or a receiver 220 appropriate to provide network communications (e.g., optical, electrical, frequency allocations, and so forth). Moreover, the transmitter 218 and receiver 220 may be coupled to one or more antennas (e.g., antenna 222) and may share circuit components, software or firmware, or alternatively be implemented separately.

In the illustrated embodiment, communication functions of the communication interface 212 may include cellular communication, Wi-Fi communication, LPWAN communication, data communication, voice communication, multimedia communication, short-range communications such as Bluetooth, near-field communication, location-based communication such as the use of the global positioning system (GPS) to determine a location, another like communication function, or any combination thereof. Communications may be implemented in according to one or more communication protocols and/or standards, such as IEEE 802.11, Code Division Multiplexing Access (CDMA), Wideband Code Division Multiple Access (WCDMA), GSM, LTE, New Radio (NR), UMTS, WiMax, Ethernet, transmission control protocol/internet protocol (TCP/IP), synchronous optical networking (SONET), Asynchronous Transfer Mode (ATM), QUIC, Hypertext Transfer Protocol (HTTP), and so forth.

Regardless of the type of sensor, a UE may provide an output of data captured by its sensors, through its communication interface 212, via a wireless connection to a network node. Data captured by sensors of a UE can be communicated through a wireless connection to a network node via another UE. The output may be periodic (e.g., once every 15 minutes if it reports the sensed temperature), random (e.g., to even out the load from reporting from several sensors), in response to a triggering event (e.g., when moisture is detected an alert is sent), in response to a request (e.g., a user initiated request), or a continuous stream (e.g., a live video feed of a patient).

As another example, a UE comprises an actuator, a motor, or a switch, related to a communication interface configured to receive wireless input from a network node via a wireless connection. In response to the received wireless input the states of the actuator, the motor, or the switch may change. For example, the UE may comprise a motor that adjusts the control surfaces or rotors of a drone in flight according to the received input or to a robotic arm performing a medical procedure according to the received input.

A UE, when in the form of an Internet of Things (IoT) device, may be a device for use in one or more application domains, these domains comprising, but not limited to, city wearable technology, extended industrial application and healthcare. Non-limiting examples of such an IoT device are a device which is or which is embedded in: a connected refrigerator or freezer, a TV, a connected lighting device, an electricity meter, a robot vacuum cleaner, a voice controlled smart speaker, a home security camera, a motion detector, a thermostat, a smoke detector, a door/window sensor, a flood/moisture sensor, an electrical door lock, a connected doorbell, an air conditioning system like a heat pump, an autonomous vehicle, a surveillance system, a weather monitoring device, a vehicle parking monitoring device, an electric vehicle charging station, a smart watch, a fitness tracker, a head-mounted display for Augmented Reality (AR) or Virtual Reality (VR), a wearable for tactile augmentation or sensory enhancement, a water sprinkler, an animal- or item-tracking device, a sensor for monitoring a plant or animal, an industrial robot, an Unmanned Aerial Vehicle (UAV), and any kind of medical device, like a heart rate monitor or a remote controlled surgical robot. A UE in the form of an IoT device comprises circuitry and/or software in dependence of the intended application of the IoT device in addition to other components as described in relation to the UE 200 shown in FIG. 6.

As yet another specific example, in an IoT scenario, a UE may represent a machine or other device that performs monitoring and/or measurements, and transmits the results of such monitoring and/or measurements to another UE and/or a network node. The UE may in this case be an M2M device, which may in a 3GPP context be referred to as an MTC device. As one particular example, the UE may implement the 3GPP NB-IoT standard. In other scenarios, a UE may represent a vehicle, such as a car, a bus, a truck, a ship and an airplane, or other equipment that is capable of monitoring and/or reporting on its operational status or other functions associated with its operation.

In practice, any number of UEs may be used together with respect to a single use case. For example, a first UE might be or be integrated in a drone and provide the drone's speed information (obtained through a speed sensor) to a second UE that is a remote controller operating the drone. When the user makes changes from the remote controller, the first UE may adjust the throttle on the drone (e.g. by controlling an actuator) to increase or decrease the drone's speed. The first and/or the second UE can also include more than one of the functionalities described above. For example, a UE might comprise the sensor and the actuator, and handle communication of data for both the speed sensor and the actuators.

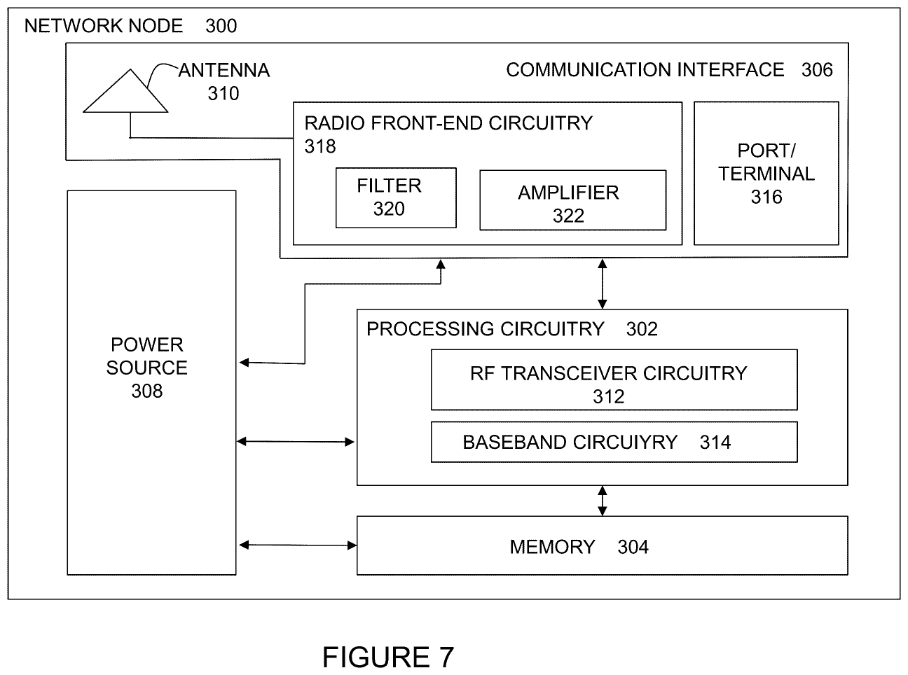

FIG. 7 shows a network node 300 in accordance with some embodiments. As used herein, network node refers to equipment capable, configured, arranged and/or operable to communicate directly or indirectly with a UE and/or with other network nodes or equipment, in a telecommunication network. Examples of network nodes include, but are not limited to, access points (APs) (e.g., radio access points), base stations (BSs) (e.g., radio base stations, Node Bs, evolved Node Bs (eNBs) and NR NodeBs (gNBs)).

Base stations may be categorized based on the amount of coverage they provide (or, stated differently, their transmit power level) and so, depending on the provided amount of coverage, may be referred to as femto base stations, pico base stations, micro base stations, or macro base stations. A base station may be a relay node or a relay donor node controlling a relay. A network node may also include one or more (or all) parts of a distributed radio base station such as centralized digital units and/or remote radio units (RRUs), sometimes referred to as Remote Radio Heads (RRHs). Such remote radio units may or may not be integrated with an antenna as an antenna integrated radio. Parts of a distributed radio base station may also be referred to as nodes in a distributed antenna system (DAS).

Other examples of network nodes include multiple transmission point (multi-TRP) 5G access nodes, multi-standard radio (MSR) equipment such as MSR BSs, network controllers such as radio network controllers (RNCs) or base station controllers (BSCs), base transceiver stations (BTSs), transmission points, transmission nodes, multi-cell/multicast coordination entities (MCEs), Operation and Maintenance (O&M) nodes, Operations Support System (OSS) nodes, Self-Organizing Network (SON) nodes, positioning nodes (e.g., Evolved Serving Mobile Location Centers (E-SMLCs)), and/or Minimization of Drive Tests (MDTs).

The network node 300 includes a processing circuitry 302, a memory 304, a communication interface 306, and a power source 308. The network node 300 may be composed of multiple physically separate components (e.g., a NodeB component and a RNC component, or a BTS component and a BSC component, etc.), which may each have their own respective components. In certain scenarios in which the network node 300 comprises multiple separate components (e.g., BTS and BSC components), one or more of the separate components may be shared among several network nodes. For example, a single RNC may control multiple NodeBs. In such a scenario, each unique NodeB and RNC pair, may in some instances be considered a single separate network node. In some embodiments, the network node 300 may be configured to support multiple radio access technologies (RATs). In such embodiments, some components may be duplicated (e.g., separate memory 304 for different RATs) and some components may be reused (e.g., a same antenna 310 may be shared by different RATs). The network node 300 may also include multiple sets of the various illustrated components for different wireless technologies integrated into network node 300, for example GSM, WCDMA, LTE, NR, WiFi, Zigbee, Z-wave, LoRaWAN, Radio Frequency Identification (RFID) or Bluetooth wireless technologies. These wireless technologies may be integrated into the same or different chip or set of chips and other components within network node 300.

The processing circuitry 302 may comprise a combination of one or more of a microprocessor, controller, microcontroller, central processing unit, digital signal processor, application-specific integrated circuit, field programmable gate array, or any other suitable computing device, resource, or combination of hardware, software and/or encoded logic operable to provide, either alone or in conjunction with other network node 300 components, such as the memory 304, to provide network node 300 functionality.

In some embodiments, the processing circuitry 302 includes a system on a chip (SOC). In some embodiments, the processing circuitry 302 includes one or more of radio frequency (RF) transceiver circuitry 312 and baseband processing circuitry 314. In some embodiments, the radio frequency (RF) transceiver circuitry 312 and the baseband processing circuitry 314 may be on separate chips (or sets of chips), boards, or units, such as radio units and digital units. In alternative embodiments, part or all of RF transceiver circuitry 312 and baseband processing circuitry 314 may be on the same chip or set of chips, boards, or units.

The memory 304 may comprise any form of volatile or non-volatile computer-readable memory including, without limitation, persistent storage, solid-state memory, remotely mounted memory, magnetic media, optical media, random access memory (RAM), read-only memory (ROM), mass storage media (for example, a hard disk), removable storage media (for example, a flash drive, a Compact Disk (CD) or a Digital Video Disk (DVD)), and/or any other volatile or non-volatile, non-transitory device-readable and/or computer-executable memory devices that store information, data, and/or instructions that may be used by the processing circuitry 302. The memory 304 may store any suitable instructions, data, or information, including a computer program, software, an application including one or more of logic, rules, code, tables, and/or other instructions capable of being executed by the processing circuitry 302 and utilized by the network node 300. The memory 304 may be used to store any calculations made by the processing circuitry 302 and/or any data received via the communication interface 306. In some embodiments, the processing circuitry 302 and memory 304 is integrated.

The communication interface 306 is used in wired or wireless communication of signaling and/or data between a network node, access network, and/or UE. As illustrated, the communication interface 306 comprises port(s)/terminal(s) 316 to send and receive data, for example to and from a network over a wired connection. The communication interface 306 also includes radio front-end circuitry 318 that may be coupled to, or in certain embodiments a part of, the antenna 310. Radio front-end circuitry 318 comprises filters 320 and amplifiers 322. The radio front-end circuitry 318 may be connected to an antenna 310 and processing circuitry 302. The radio front-end circuitry may be configured to condition signals communicated between antenna 310 and processing circuitry 302. The radio front-end circuitry 318 may receive digital data that is to be sent out to other network nodes or UEs via a wireless connection. The radio front-end circuitry 318 may convert the digital data into a radio signal having the appropriate channel and bandwidth parameters using a combination of filters 320 and/or amplifiers 322. The radio signal may then be transmitted via the antenna 310. Similarly, when receiving data, the antenna 310 may collect radio signals which are then converted into digital data by the radio front-end circuitry 318. The digital data may be passed to the processing circuitry 302. In other embodiments, the communication interface may comprise different components and/or different combinations of components.

In certain alternative embodiments, the network node 300 does not include separate radio front-end circuitry 318, instead, the processing circuitry 302 includes radio front-end circuitry and is connected to the antenna 310. Similarly, in some embodiments, all or some of the RF transceiver circuitry 312 is part of the communication interface 306. In still other embodiments, the communication interface 306 includes one or more ports or terminals 316, the radio front-end circuitry 318, and the RF transceiver circuitry 312, as part of a radio unit (not shown), and the communication interface 306 communicates with the baseband processing circuitry 314, which is part of a digital unit (not shown).

The antenna 310 may include one or more antennas, or antenna arrays, configured to send and/or receive wireless signals. The antenna 310 may be coupled to the radio front-end circuitry 318 and may be any type of antenna capable of transmitting and receiving data and/or signals wirelessly. In certain embodiments, the antenna 310 is separate from the network node 300 and connectable to the network node 300 through an interface or port.

The antenna 310, communication interface 306, and/or the processing circuitry 302 may be configured to perform any receiving operations and/or certain obtaining operations described herein as being performed by the network node. Any information, data and/or signals may be received from a UE, another network node and/or any other network equipment. Similarly, the antenna 310, the communication interface 306, and/or the processing circuitry 302 may be configured to perform any transmitting operations described herein as being performed by the network node. Any information, data and/or signals may be transmitted to a UE, another network node and/or any other network equipment.

The power source 308 provides power to the various components of network node 300 in a form suitable for the respective components (e.g., at a voltage and current level needed for each respective component). The power source 308 may further comprise, or be coupled to, power management circuitry to supply the components of the network node 300 with power for performing the functionality described herein. For example, the network node 300 may be connectable to an external power source (e.g., the power grid, an electricity outlet) via an input circuitry or interface such as an electrical cable, whereby the external power source supplies power to power circuitry of the power source 308. As a further example, the power source 308 may comprise a source of power in the form of a battery or battery pack which is connected to, or integrated in, power circuitry. The battery may provide backup power should the external power source fail.

Embodiments of the network node 300 may include additional components beyond those shown in FIG. 7 for providing certain aspects of the network node's functionality, including any of the functionality described herein and/or any functionality necessary to support the subject matter described herein. For example, the network node 300 may include user interface equipment to allow input of information into the network node 300 and to allow output of information from the network node 300. This may allow a user to perform diagnostic, maintenance, repair, and other administrative functions for the network node 300.

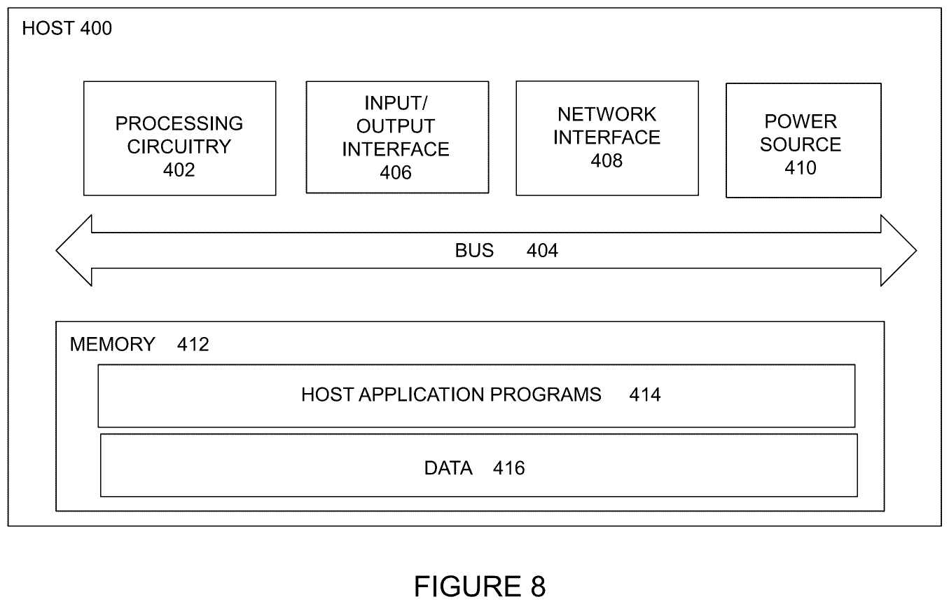

FIG. 8 is a block diagram of a host 400, which may be an embodiment of the host 116 of FIG. 5, in accordance with various aspects described herein. As used herein, the host 400 may be or comprise various combinations hardware and/or software, including a standalone server, a blade server, a cloud-implemented server, a distributed server, a virtual machine, container, or processing resources in a server farm. The host 400 may provide one or more services to one or more UEs.

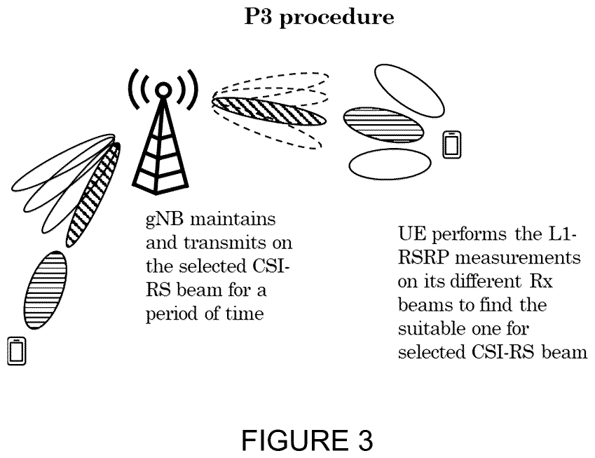

The host 400 includes processing circuitry 402 that is operatively coupled via a bus 404 to an input/output interface 406, a network interface 408, a power source 410, and a memory 412. Other components may be included in other embodiments. Features of these components may be substantially similar to those described with respect to the devices of previous figures, such as FIGS. 2 and 3, such that the descriptions thereof are generally applicable to the corresponding components of host 400.

The memory 412 may include one or more computer programs including one or more host application programs 414 and data 416, which may include user data, e.g., data generated by a UE for the host 400 or data generated by the host 400 for a UE. Embodiments of the host 400 may utilize only a subset or all of the components shown. The host application programs 414 may be implemented in a container-based architecture and may provide support for video codecs (e.g., Versatile Video Coding (VVC), High Efficiency Video Coding (HEVC), Advanced Video Coding (AVC), MPEG, VP9) and audio codecs (e.g., FLAC, Advanced Audio Coding (AAC), MPEG, G.711), including transcoding for multiple different classes, types, or implementations of UEs (e.g., handsets, desktop computers, wearable display systems, heads-up display systems). The host application programs 414 may also provide for user authentication and licensing checks and may periodically report health, routes, and content availability to a central node, such as a device in or on the edge of a core network. Accordingly, the host 400 may select and/or indicate a different host for over-the-top services for a UE. The host application programs 414 may support various protocols, such as the HTTP Live Streaming (HLS) protocol, Real-Time Messaging Protocol (RTMP), Real-Time Streaming Protocol (RTSP), Dynamic Adaptive Streaming over HTTP (MPEG-DASH), etc.

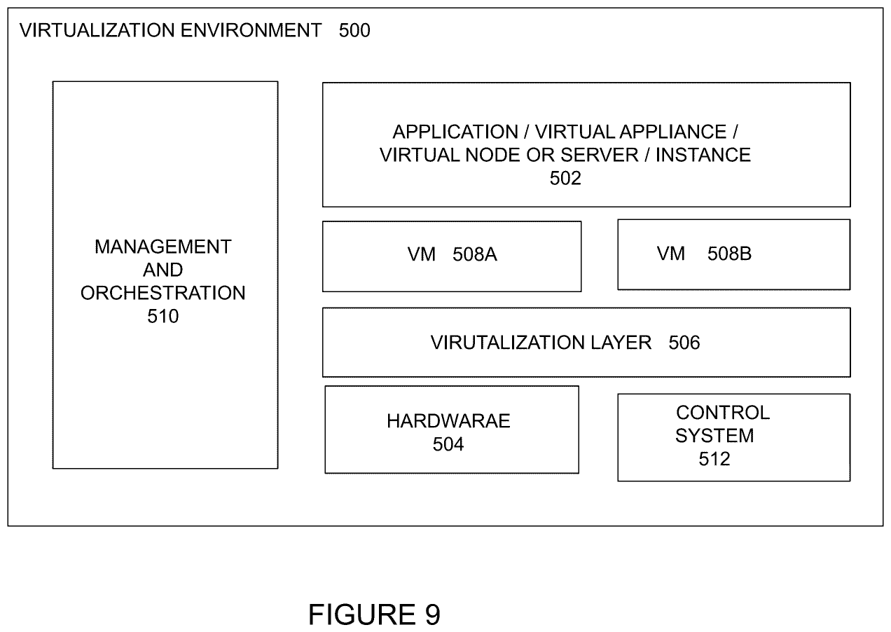

FIG. 9 is a block diagram illustrating a virtualization environment 500 in which functions implemented by some embodiments may be virtualized.

In the present context, virtualizing means creating virtual versions of apparatuses or devices which may include virtualizing hardware platforms, storage devices and networking resources. As used herein, virtualization can be applied to any device described herein, or components thereof, and relates to an implementation in which at least a portion of the functionality is implemented as one or more virtual components. Some or all of the functions described herein may be implemented as virtual components executed by one or more virtual machines (VMs) implemented in one or more virtual environments 500 hosted by one or more of hardware nodes, such as a hardware computing device that operates as a network node, UE, core network node, or host. Further, in embodiments in which the virtual node does not require radio connectivity (e.g., a core network node or host), then the node may be entirely virtualized.

Applications 502 (which may alternatively be called software instances, virtual appliances, network functions, virtual nodes, virtual network functions, etc.) are run in the virtualization environment Q400 to implement some of the features, functions, and/or benefits of some of the embodiments disclosed herein.

Hardware 504 includes processing circuitry, memory that stores software and/or instructions executable by hardware processing circuitry, and/or other hardware devices as described herein, such as a network interface, input/output interface, and so forth. Software may be executed by the processing circuitry to instantiate one or more virtualization layers 506 (also referred to as hypervisors or virtual machine monitors (VMMs)), provide VMs 508a and 508b (one or more of which may be generally referred to as VMs 508), and/or perform any of the functions, features and/or benefits described in relation with some embodiments described herein. The virtualization layer 506 may present a virtual operating platform that appears like networking hardware to the VMs 508.

The VMs 508 comprise virtual processing, virtual memory, virtual networking or interface and virtual storage, and may be run by a corresponding virtualization layer 506. Different embodiments of the instance of a virtual appliance 502 may be implemented on one or more of VMs 508, and the implementations may be made in different ways. Virtualization of the hardware is in some contexts referred to as network function virtualization (NFV). NFV may be used to consolidate many network equipment types onto industry standard high volume server hardware, physical switches, and physical storage, which can be located in data centers, and customer premise equipment.

In the context of NFV, a VM 508 may be a software implementation of a physical machine that runs programs as if they were executing on a physical, non-virtualized machine. Each of the VMs 508, and that part of hardware 504 that executes that VM, be it hardware dedicated to that VM and/or hardware shared by that VM with others of the VMs, forms separate virtual network elements. Still in the context of NFV, a virtual network function is responsible for handling specific network functions that run in one or more VMs 508 on top of the hardware 504 and corresponds to the application 502.

Hardware 504 may be implemented in a standalone network node with generic or specific components. Hardware 504 may implement some functions via virtualization. Alternatively, hardware 504 may be part of a larger cluster of hardware (e.g. such as in a data center or CPE) where many hardware nodes work together and are managed via management and orchestration 510, which, among others, oversees lifecycle management of applications 502. In some embodiments, hardware 504 is coupled to one or more radio units that each include one or more transmitters and one or more receivers that may be coupled to one or more antennas. Radio units may communicate directly with other hardware nodes via one or more appropriate network interfaces and may be used in combination with the virtual components to provide a virtual node with radio capabilities, such as a radio access node or a base station. In some embodiments, some signaling can be provided with the use of a control system 512 which may alternatively be used for communication between hardware nodes and radio units.

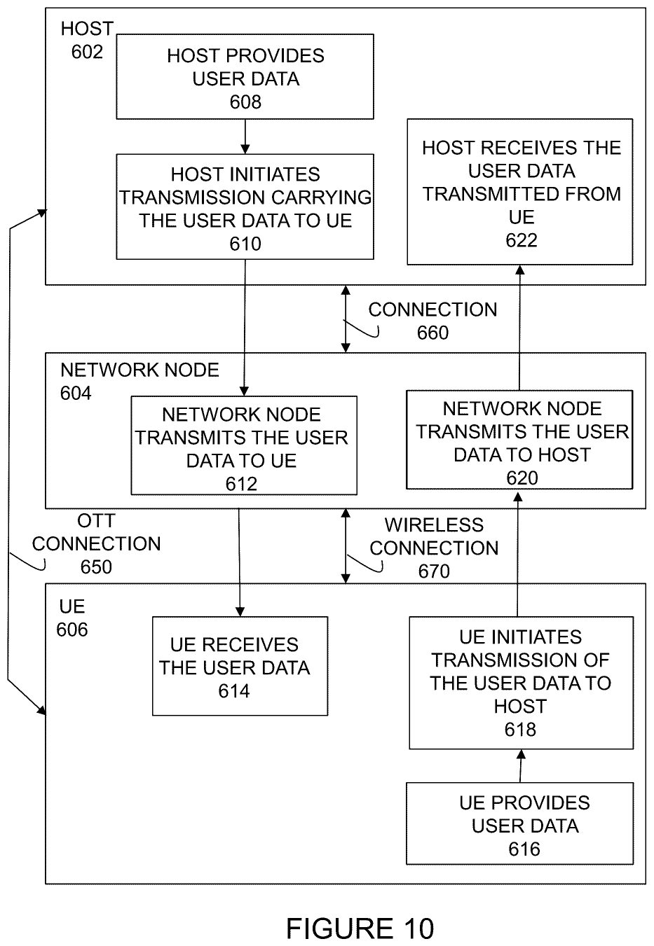

FIG. 10 shows a communication diagram of a host 602 communicating via a network node 604 with a UE 606 over a partially wireless connection in accordance with some embodiments.

Example implementations, in accordance with various embodiments, of the UE (such as a UE 112a of FIG. 5 and/or UE 200 of FIG. 6), network node (such as network node 110a of FIG. 5 and/or network node 300 of FIG. 7), and host (such as host 116 of FIG. 5 and/or host 400 of FIG. 8) discussed in the preceding paragraphs will now be described with reference to FIG. 10.

Like host 400, embodiments of host 602 include hardware, such as a communication interface, processing circuitry, and memory. The host 602 also includes software, which is stored in or accessible by the host 602 and executable by the processing circuitry. The software includes a host application that may be operable to provide a service to a remote user, such as the UE 606 connecting via an over-the-top (OTT) connection 650 extending between the UE 606 and host 602. In providing the service to the remote user, a host application may provide user data which is transmitted using the OTT connection 650.

The network node 604 includes hardware enabling it to communicate with the host 602 and UE 606. The connection 660 may be direct or pass through a core network (like core network 106 of FIG. 5) and/or one or more other intermediate networks, such as one or more public, private, or hosted networks. For example, an intermediate network may be a backbone network or the Internet.

The UE 606 includes hardware and software, which is stored in or accessible by UE 606 and executable by the UE's processing circuitry. The software includes a client application, such as a web browser or operator-specific “app” that may be operable to provide a service to a human or non-human user via UE 606 with the support of the host 602. In the host 602, an executing host application may communicate with the executing client application via the OTT connection 650 terminating at the UE 606 and host 602. In providing the service to the user, the UE's client application may receive request data from the host's host application and provide user data in response to the request data. The OTT connection 650 may transfer both the request data and the user data. The UE's client application may interact with the user to generate the user data that it provides to the host application through the OTT connection 650.

The OTT connection 650 may extend via a connection 660 between the host 602 and the network node 604 and via a wireless connection 670 between the network node 604 and the UE 606 to provide the connection between the host 602 and the UE 606. The connection 660 and wireless connection 670, over which the OTT connection 650 may be provided, have been drawn abstractly to illustrate the communication between the host 602 and the UE 606 via the network node 604, without explicit reference to any intermediary devices and the precise routing of messages via these devices.

As an example of transmitting data via the OTT connection 650, in step 608, the host 602 provides user data, which may be performed by executing a host application. In some embodiments, the user data is associated with a particular human user interacting with the UE 606. In other embodiments, the user data is associated with a UE 606 that shares data with the host 602 without explicit human interaction. In step 610, the host 602 initiates a transmission carrying the user data towards the UE 606. The host 602 may initiate the transmission responsive to a request transmitted by the UE 606. The request may be caused by human interaction with the UE 606 or by operation of the client application executing on the UE 606. The transmission may pass via the network node 604, in accordance with the teachings of the embodiments described throughout this disclosure. Accordingly, in step 612, the network node 604 transmits to the UE 606 the user data that was carried in the transmission that the host 602 initiated, in accordance with the teachings of the embodiments described throughout this disclosure. In step 614, the UE 606 receives the user data carried in the transmission, which may be performed by a client application executed on the UE 606 associated with the host application executed by the host 602.

In some examples, the UE 606 executes a client application which provides user data to the host 602. The user data may be provided in reaction or response to the data received from the host 602. Accordingly, in step 616, the UE 606 may provide user data, which may be performed by executing the client application. In providing the user data, the client application may further consider user input received from the user via an input/output interface of the UE 606. Regardless of the specific manner in which the user data was provided, the UE 606 initiates, in step 618, transmission of the user data towards the host 602 via the network node 604. In step 620, in accordance with the teachings of the embodiments described throughout this disclosure, the network node 604 receives user data from the UE 606 and initiates transmission of the received user data towards the host 602. In step 622, the host 602 receives the user data carried in the transmission initiated by the UE 606.

One or more of the various embodiments improve the performance of OTT services provided to the UE 606 using the OTT connection 650, in which the wireless connection 670 forms the last segment. More precisely, the teachings of these embodiments may improve one or more of, for example, data rate, latency, and/or power consumption and, thereby, provide benefits such as, for example, reduced user waiting time, relaxed restriction on file size, improved content resolution, better responsiveness, and/or extended battery lifetime.

In an example scenario, factory status information may be collected and analyzed by the host 602. As another example, the host 602 may process audio and video data which may have been retrieved from a UE for use in creating maps. As another example, the host 602 may collect and analyze real-time data to assist in controlling vehicle congestion (e.g., controlling traffic lights). As another example, the host 602 may store surveillance video uploaded by a UE. As another example, the host 602 may store or control access to media content such as video, audio, VR or AR which it can broadcast, multicast or unicast to UEs. As other examples, the host 602 may be used for energy pricing, remote control of non-time critical electrical load to balance power generation needs, location services, presentation services (such as compiling diagrams etc. from data collected from remote devices), or any other function of collecting, retrieving, storing, analyzing and/or transmitting data.

In some examples, a measurement procedure may be provided for the purpose of monitoring data rate, latency and other factors on which the one or more embodiments improve. There may further be an optional network functionality for reconfiguring the OTT connection 650 between the host 602 and UE 606, in response to variations in the measurement results. The measurement procedure and/or the network functionality for reconfiguring the OTT connection may be implemented in software and hardware of the host 602 and/or UE 606. In some embodiments, sensors (not shown) may be deployed in or in association with other devices through which the OTT connection 650 passes; the sensors may participate in the measurement procedure by supplying values of the monitored quantities exemplified above, or supplying values of other physical quantities from which software may compute or estimate the monitored quantities. The reconfiguring of the OTT connection 650 may include message format, retransmission settings, preferred routing etc.; the reconfiguring need not directly alter the operation of the network node 604. Such procedures and functionalities may be known and practiced in the art. In certain embodiments, measurements may involve proprietary UE signaling that facilitates measurements of throughput, propagation times, latency and the like, by the host 602. The measurements may be implemented in that software causes messages to be transmitted, in particular empty or ‘dummy’ messages, using the OTT connection 650 while monitoring propagation times, errors, etc.

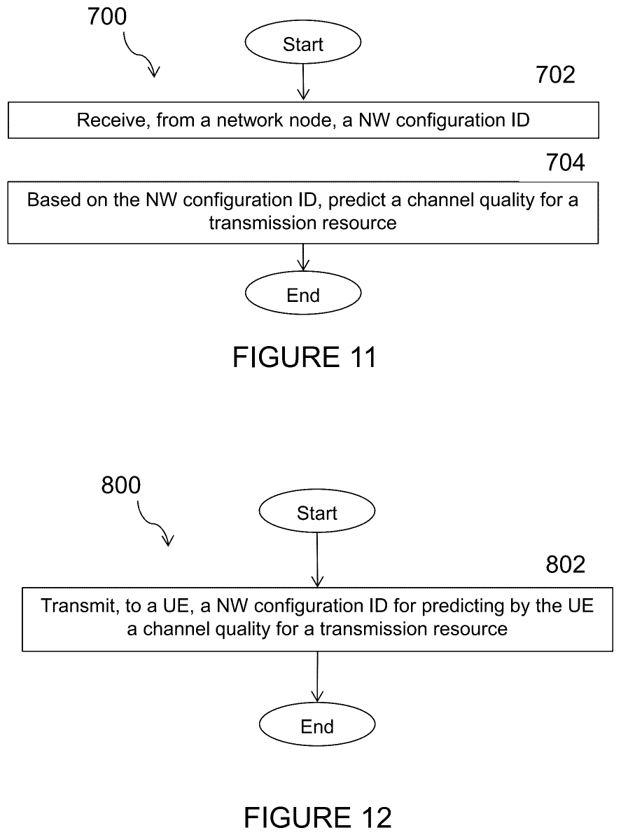

FIG. 11 illustrates an example method 700 by a UE 112, according to certain embodiments. The method begins at step 704 when the UE 112 receives, from a network node 110, at least one NW configuration ID. Based on the at least one NW configuration ID, the UE 112 predicts a channel quality for a transmission resource, at step 704.

In a particular embodiment, the UE 112 transmits, to the network node 110, a request for the at least one NW configuration ID. The at least one NW configuration ID is received based on the request for the at least one NW configuration ID.

In a particular embodiment, the at least one NW configuration ID comprises or is associated with at least one of: a network configuration; a beam configuration; a beam identifier; a parameter of configuration associated with beam management; a set of precoders used by the network node; a serving cell of the network node; and a number of beams and/or a beamforming pattern of the network node.

In a particular embodiment, the beam identifier is associated with a precoder used by the network node.

In a particular embodiment, the transmission resource comprises at least one of: a time resource, a frequency resource, a time-frequency resource, a CSI-RS resource, a TRS resource, a PRS resource, and a SSB resource.

In a particular embodiment, based on the at least one NW configuration ID, the UE 112 trains a ML model to predict at least one other NW configuration ID.

In a particular embodiment, based on the at least one NW configuration ID, the UE 112 performs at least one measurement on the transmission resource during a first time period. The UE 112 stores data associated with the at least one measurement, and the data includes at least one value associated with the at least one measurement performed during the first time period.

In a particular embodiment, when predicting the channel quality for the transmission resource, the UE 112 uses the data associated with the at least one measurement performed during the first time period to build a ML model for the at least one NW configuration ID and uses the ML model to generate one or more ML model outputs that predict the channel quality for the transmission resource for a second time period.

In a particular embodiment, the data associated with the at least one measurement is used to build the ML model once a minimum amount of data is obtained, and the minimum amount of data includes N number of data samples or N number of measurement values.

In a particular embodiment, the one or more ML model outputs includes one or more values and/or characteristics indicating the channel quality of the transmission resource during the second time period.

In a particular embodiment, the UE 112 transmits the predicted channel quality for the transmission resource to at least one of: the network node, another network node, and/or another UE.

In a particular embodiment, the UE 112 determines a confidence level associated with the predicted channel quality for the transmission resource and transmits the confidence level associated with the predicted channel quality for the transmission resource to at least one of: the network node, another network node, and/or another UE.

In a particular embodiment, each NW configuration ID comprises a plurality of information elements, and each of the plurality of information elements is associated with an element of a network configuration, One or more of the plurality of information elements is based on and/or indicative of at least one of the following: deployment information, hardware information, and beamforming information. The deployment information includes at least one of: an antenna physical tilt; an antenna physical direction; and/or an antenna position. The hardware information includes at least one of: an antenna panel; an antenna design; and/or an impairment characteristic. The beamforming information indicates a beam and/or a transmission power.

In a particular embodiment, a first portion of the plurality of information elements is received in a first signal from the network node, and a second portion of the plurality of information elements is received in a second signal from the network node.

In a particular embodiment, the at least one NW configuration ID is received in one or more messages. The one or more messages include any one or combination of: one or more cell-specific RRC messages; one or more RRC messages that are sent to the UE during an access procedure; and one or more RRC messages that is UE-specific and sent to the UE after the UE is connected to the network.

In a particular embodiment, the at least one NW configuration ID is received in any one or combination of: one or more MAC CEs; one or more DCIs; a message associated with a measurement reference signal resource configuration; and a message associated with a network configuration change.

In a particular embodiment, the at least one NW configuration ID is received as a part of an NZP-CSI-RS-Resource information element.

In a particular embodiment, the UE 112 transmits, to the network node, a request for assistance information associated with the at least one NW configuration ID and receives the assistance information from the network node. The assistance information includes at least one of: an amount of time the at least one NW configuration ID has been or is expected to be valid, a validity associated with at least one information element of the at least one NW configuration ID; one or more statistics related to a use of the at least one NW configuration ID; and an indication that the at least one NW configuration ID is no longer valid.

FIG. 12 illustrates an example method 800 by a network node 110, according to certain embodiments. The method includes, at step 802, transmitting, to a UE 112, at least one NW configuration ID for predicting, by the UE, a channel quality for a transmission resource.

In a particular embodiment, the network node 110 receives, from the UE 112, the predicted channel quality for the transmission resource.

In a particular embodiment, the network node 110 receives from the UE, a request for the at least one NW configuration ID, and the at least one NW configuration ID is transmitted to the UE based on the request for the at least one NW configuration ID.

In a particular embodiment, the at least one NW configuration ID includes and/or is associated with at least one of: a network configuration; a beam configuration; a beam identifier; a parameter of a configuration associated with beam management; a set of precoders used by the network node; a serving cell of the network node; and a number of beams and/or a beamforming pattern of the network node.

In a particular embodiment, the beam identifier is associated with a precoder used by the network node.

In a particular embodiment, the transmission resource comprises at least one of: a time resource, a frequency resource, a time-frequency resource, a CSI-RS resource, a TRS resource, a PRS resource, and a SSB resource.

In a particular embodiment, the network node 110 transmits, to the UE 112, at least one signal in the transmission resource, and the UE is configured to perform at least one measurement on the transmission resource during a first time period and to store data associated with the at least one measurement. The data associated includes at least one value associated with the at least one measurement performed during the first time period.

In a particular embodiment, the network node 110 configures the UE 112 to predict the channel quality for the transmission resource. Based on the configuring, the UE 112 uses the data associated with the at least one measurement performed during the first time period to build a ML model for the at least one NW configuration ID and uses the ML model to generate one or more ML model outputs that predict the channel quality for the transmission resource for a second time period.

In a particular embodiment, the network node 110 configures the UE 112 to build the ML after a minimum amount of data is obtained. The minimum amount of data includes N number of data samples or N number of measurement values.

In a particular embodiment, the one or more ML model outputs include one or more values and/or characteristics indicating the channel quality of the transmission resource during the second time period.

In a particular embodiment, the network node 110 receives, from the UE 112, a confidence level associated with the predicted channel quality for the transmission resource.

In a particular embodiment, each NW configuration ID comprises a plurality of information elements, and each of the plurality of information elements is associated with an element of a network configuration. One or more of the plurality of information elements is based on and/or indicative of at least one of the following: deployment information, hardware information, and beamforming information. The deployment information includes at least one of: an antenna physical tilt; an antenna physical direction; and/or an antenna position. The hardware information includes at least one of: an antenna panel; an antenna design; and/or an impairment characteristic. The beamforming information indicates a beam and/or a transmission power.

In a particular embodiment, a first portion of the plurality of information elements is transmitted in a first signal, and a second portion of the plurality of information elements is transmitted in a second signal.

In a particular embodiment, the at least one NW configuration ID is transmitted in one or more messages. The one or more messages include any one or combination of: one or more cell-specific RRC messages; one or more RRC messages that are sent to the UE during an access procedure; and one or more RRC messages that is UE-specific and sent to the UE after the UE is connected to the network.

In a particular embodiment, the at least one NW configuration ID is transmitted in any one or combination of: one or more MAC CEs, one or more DCIs, a message associated with a measurement reference signal resource configuration, and a message associated with a network configuration change.

In a particular embodiment, the at least one NW configuration ID is transmitted as a part of an NZP-CSI-RS-Resource information element.

In a particular embodiment, the network node 110 receives, from the UE 112, a request for assistance information associated with the at least one NW configuration ID, and transmits, to the UE, the assistance information. The assistance information includes at least one of: an amount of time the at least one NW configuration ID has been or is expected to be valid, a validity associated with at least one information element of the at least one NW configuration ID; one or more statistics related to a use of the at least one NW configuration ID; and an indication that the at least one NW configuration ID is no longer valid.

Although the computing devices described herein (e.g., UEs, network nodes, hosts) may include the illustrated combination of hardware components, other embodiments may comprise computing devices with different combinations of components. It is to be understood that these computing devices may comprise any suitable combination of hardware and/or software needed to perform the tasks, features, functions and methods disclosed herein. Determining, calculating, obtaining or similar operations described herein may be performed by processing circuitry, which may process information by, for example, converting the obtained information into other information, comparing the obtained information or converted information to information stored in the network node, and/or performing one or more operations based on the obtained information or converted information, and as a result of said processing making a determination. Moreover, while components are depicted as single boxes located within a larger box, or nested within multiple boxes, in practice, computing devices may comprise multiple different physical components that make up a single illustrated component, and functionality may be partitioned between separate components. For example, a communication interface may be configured to include any of the components described herein, and/or the functionality of the components may be partitioned between the processing circuitry and the communication interface. In another example, non-computationally intensive functions of any of such components may be implemented in software or firmware and computationally intensive functions may be implemented in hardware.

In certain embodiments, some or all of the functionality described herein may be provided by processing circuitry executing instructions stored on in memory, which in certain embodiments may be a computer program product in the form of a non-transitory computer-readable storage medium. In alternative embodiments, some or all of the functionality may be provided by the processing circuitry without executing instructions stored on a separate or discrete device-readable storage medium, such as in a hard-wired manner. In any of those particular embodiments, whether executing instructions stored on a non-transitory computer-readable storage medium or not, the processing circuitry can be configured to perform the described functionality. The benefits provided by such functionality are not limited to the processing circuitry alone or to other components of the computing device, but are enjoyed by the computing device as a whole, and/or by end users and a wireless network generally.

### EXAMPLE EMBODIMENTS

### Group A Example Embodiments

Example Embodiment A1. A method by a user equipment for comprising: any of the user equipment steps, features, or functions described above, either alone or in combination with other steps, features, or functions described above.

Example Embodiment A2. The method of the previous embodiment, further comprising one or more additional user equipment steps, features or functions described above.

Example Embodiment A3. The method of any of the previous embodiments, further comprising: providing user data; and forwarding the user data to a host computer via the transmission to the network node.

### Group B Example Embodiments

Example Embodiment B1. A method performed by a network node comprising: any of the network node steps, features, or functions described above, either alone or in combination with other steps, features, or functions described above.

Example Embodiment B2. The method of the previous embodiment, further comprising one or more additional network node steps, features or functions described above.

Example Embodiment B3. The method of any of the previous embodiments, further comprising: obtaining user data; and forwarding the user data to a host or a user equipment.

### Group C Example Embodiments

Example Embodiment C1. A method by a user equipment (UE) comprising:
receiving, from a network node, a network configuration identifier (NW configuration ID); and based on the NW configuration ID, predicting a channel quality for a transmission resource.

Example Embodiment C2A. The method of Example Embodiment C1, wherein the NW configuration ID is associated with a network configuration, a beam configuration, and/or a beam ID.

Example Embodiment C2B. The method of any one of Example Embodiments C1 to C2A, wherein predicting the channel quality of the transmission resource comprises: determining a predictability of an effective channel.

Example Embodiment C3. The method of any one of Example Embodiments C1 to C2B, wherein the NW configuration ID comprises or is associated with at least one of: a parameter of configuration associated with beam management; a precoder used by the network node; a serving cell of the network node; and a number of beams and/or a beamforming pattern of the network node.

Example Embodiment C4. The method of any one of Example Embodiments C1 to C3, wherein the transmission resource comprises at least one of a time resource, a frequency resource and/or a time-frequency resource.

Example Embodiment C5. The method of any one of Example Embodiments C1 to C4, wherein the transmission resource comprises at least one of: a CSI-RS resource, a TRS resource, and a SSB resource.

Example Embodiment C6. The method of any one of Example Embodiments C1 to C5, further comprising: based on the NW configuration ID, performing at least one measurement on the transmission resource, wherein the at least one measurement is performed during a first time period; and storing data associated with the at least one measurement.

Example Embodiment C7. The method of Example Embodiment C6, wherein the data associated with the at least one measurement comprises at least one value indicating a channel quality of the transmission resource during the first time period.

Example Embodiment C8a. The method of any one of Example Embodiments C6 to C7, wherein predicting the channel quality for the transmission resource comprises: using the data associated with the at least one measurement performed during the first time period to build a machine-learning (ML) model for the NW configuration ID; and using the ML model to generate one or more ML model outputs that predict the channel quality for the transmission resource for a second time period.

Example Embodiment C8b. The method of Example Embodiment C8a, wherein the data associated with the at least one measurement is used to build the ML model once a minimum amount of data is obtained.

Example Embodiment C8c. The method of Example Embodiment C8b wherein the minimum amount of data comprises N number of data samples or N number of measurement values.

Example Embodiment C9. The method of Example Embodiment C8c, wherein the first time period comprises at least one data collection and/or learning time period, and wherein the second time period is after the first time period.

Example Embodiment C10. The method of any one of Example Embodiments C6 to C9, wherein the first time period and/or the second time period are associated with a RRC connection instance.

Example Embodiment C11. The method of any one of example Embodiments C6 to C9, wherein the first time period is associated with a first RRC connection instance and/or the second time period is associated with a second RRC connection instance.

Example Embodiment C12. The method of any one of Example Embodiments C8a to C11, wherein the second time period is a period of time in the future.

Example Embodiment C13. The method of any one of Example Embodiments C8a to C12, wherein the one or more ML model outputs comprise one or more values and/or characteristics indicating the channel quality of the transmission resource during the second time period.

Example Embodiment C14. The method of any one of Example Embodiments C1 to C13, further comprising transmitting the predicted channel quality for the transmission resource to at least one of: the network node, another network node, and/or another UE.

Example Embodiment C15. The method of any one of Example Embodiments C1 to C14, further comprising determining a confidence level associated with the predicted channel quality for the transmission resource.

Example Embodiment C16. The method of Example Embodiment C15, further comprising transmitting the confidence level associated with the predicted channel quality for the transmission resource to at least one of: the network node, another network node, and/or another UE.

Example Embodiment C17. The method of any one of Example Embodiments C1 to C16, wherein NW configuration ID comprises a plurality of information elements, and wherein each of the plurality of information elements is associated with an element of a network configuration.

Example Embodiment C18. The method of Example Embodiment C17, wherein one or more of the plurality of information elements is based on and/or indicative of at last one of the following: deployment information comprising at least one of: an antenna physical tilt; an antenna physical direction; and/or an antenna position; hardware information comprising at least one of: an antenna panel; an antenna design; and/or an impairment characteristic; beamforming information indicating a beam and/or a transmission power.

Example Embodiment C19. The method of any one of Example Embodiments C17 to C18, wherein a first portion of the plurality of information elements is received in a first signal from the network node, and wherein a second portion of the plurality of information elements is received in a second signal from the network node.

Example Embodiment C20. The method of any one of Example Embodiments C1 to C19, wherein the NW configuration ID is received in one or more messages, the one or more messages comprising any one or combination of: one or more cell-specific RRC messages (e.g., SIB messages); one or more RRC messages that are send to the UE during an access procedure; and one or more RRC messages that is UE-specific and sent to the UE after the UE is connected to the network.

Example Embodiment C21. The method of any one of Example Embodiments C1 to C20, wherein the NW configuration ID is received in any one or combination of: one or more MAC CEs; one or more DCIs; a message associated with a measurement RS resource configuration; and a message associated with a network configuration change.

Example Embodiment C22. The method of any one of Example Embodiments C1 to C21, further comprising transmitting, to the network node, a request for the NW configuration ID, wherein the NW configuration ID is received based on and/or in response to and/or subsequent to the request for the NW configuration ID.

Example Embodiment C23. The method of any one of Example Embodiments C1 to C22, wherein the NW configuration ID is received as a part of an NZP-CSI-RS-Resource information element.

Example Embodiment C24. The method of any one of Example Embodiments C1 to C23, further comprising: transmitting, to the network node, a request for assistance information associated with the NW configuration ID, and receiving the assistance information from the network node, and wherein the assistance information comprises: at least one of: an amount of time the NW configuration ID has been or is expected to be valid, a validity associated with at least one information element of the NW configuration ID; one or more statistics related to a use of the NW configuration ID; and an indication that the NW configuration ID is no longer valid.

Example Embodiment C25. The method of Example Embodiments C1 to C24, further comprising: providing user data; and forwarding the user data to a host via the transmission to the network node.

Example Embodiment C26. A user equipment comprising processing circuitry configured to perform any of the methods of Example Embodiments C1 to C25.

Example Embodiment C27. A wireless device comprising processing circuitry configured to perform any of the methods of Example Embodiments C1 to C25.

Example Embodiment C28. A computer program comprising instructions which when executed on a computer perform any of the methods of Example Embodiments C1 to C25.

Example Embodiment C29. A computer program product comprising computer program, the computer program comprising instructions which when executed on a computer perform any of the methods of Example Embodiments C1 to C25.

Example Embodiment C30. A non-transitory computer readable medium storing instructions which when executed by a computer perform any of the methods of Example Embodiments C1 to C25.

Example Embodiment C31. A user equipment adapted to perform any of the methods of Example Embodiments C1 to C25.

### Group D Example Embodiments

Example Embodiment D1. A method by a network node comprising: transmitting, to a UE, a network configuration identifier (NW configuration ID) for predicting, by the wireless device, a channel quality for a transmission resource.

Example Embodiment D2A. The method of Example Embodiment D1, wherein the NW configuration ID is associated with a network configuration, a beam configuration, and/or a beam ID.

Example Embodiment D2B. The method of any one of Example Embodiments D1 to D2A, wherein predicting the channel quality of the transmission resource comprises: determining a predictability of an effective channel.

Example Embodiment D3. The method of any one of Example Embodiments D1 to D2B, wherein the NW configuration ID comprises or is associated with at least one of: a parameter of a configuration associated with beam management; a precoder used by the network node; a serving cell of the network node; and a number of beams and/or a beamforming pattern of the network node.

Example Embodiment D4. The method of any one of Example Embodiments D1 to D3, wherein the transmission resource comprises at least one of a time resource, a frequency resource and/or a time-frequency resource.

Example Embodiment D5. The method of any one of Example Embodiments D1 to D4, wherein the transmission resource comprises at least one of: a CSI-RS resource, a TRS resource, and a SSB resource.

Example Embodiment D6. The method of any one of Example Embodiments D1 to D5, further comprising: transmitting, to the UE, at least one signal in the transmission resource, wherein the UE is configured to perform at least one measurement on the transmission resource during a first time period and to store data associated with the at least one measurement.

Example Embodiment D7. The method of Example Embodiment D6, wherein the data associated with the at least one measurement comprises at least one value indicating a channel quality of the transmission resource during the first time period.

Example Embodiment D8a. The method of any one of Example Embodiments D6 to D7, further comprising configuring the UE to predict the channel quality for the transmission resource by: using the data associated with the at least one measurement performed during the first time period to build a machine-learning (ML) model for the NW configuration ID; and using the ML model to generate one or more ML model outputs that predict the channel quality for the transmission resource for a second time period.

Example Embodiment D8b. The method of Example Embodiment D8a, further comprising configuring the UE to build the ML after a minimum amount of data is obtained.

Example Embodiment D8c. The method of Example Embodiment D8b wherein the minimum amount of data comprises N number of data samples or N number of measurement values.

Example Embodiment D9. The method of Example Embodiment D8c, wherein the first time period comprises at least one data collection and/or learning time period, and wherein the second time period is after the first time period.

Example Embodiment D10. The method of any one of Example Embodiments D6 to D9, wherein the first time period and/or the second time period are associated with a RRC connection instance associated with the network node.

Example Embodiment D11. The method of any one of example Embodiments D6 to D9, wherein the first time period is associated with a first RRC connection instance and/or the second time period is associated with a second RRC connection instance.

Example Embodiment D12. The method of any one of Example Embodiments D8a to D11, wherein the second time period is a period of time in the future.

Example Embodiment D13. The method of any one of Example Embodiments D8a to D12, wherein the one or more ML model outputs comprise one or more values and/or characteristics indicating the channel quality of the transmission resource during the second time period.

Example Embodiment D14. The method of any one of Example Embodiments D1 to D13, further comprising receiving, from the UE, the predicted channel quality for the transmission resource.

Example Embodiment D15. The method of any one of Example Embodiments D1 to D14, further comprising receiving, from the UE, a confidence level associated with the predicted channel quality for the transmission resource.

Example Embodiment D16. The method of any one of Example Embodiments D1 to D15, wherein the NW configuration ID comprises a plurality of information elements, and wherein each of the plurality of information elements is associated with an element of a network configuration.

Example Embodiment D17. The method of Example Embodiment D16, wherein one or more of the plurality of information elements is based on and/or indicative of at last one of the following: deployment information comprising at least one of: an antenna physical tilt; an antenna physical direction; and/or an antenna position; hardware information comprising at least one of: an antenna panel; an antenna design; and/or an impairment characteristic; beamforming information indicating a beam and/or a transmission power.

Example Embodiment D18. The method of any one of Example Embodiments D16 to D17, wherein a first portion of the plurality of information elements is transmitted in a first signal, and wherein a second portion of the plurality of information elements is transmitted in a second signal.

Example Embodiment D19. The method of any one of Example Embodiments D1 to D18, wherein the NW configuration ID is transmitted in one or more messages, the one or more messages comprising any one or combination of: one or more cell-specific RRC messages (e.g., SIB messages); one or more RRC messages that are send to the UE during an access procedure; and one or more RRC messages that is UE-specific and sent to the UE after the UE is connected to the network.

Example Embodiment D20. The method of any one of Example Embodiments D1 to D19, wherein the NW configuration ID is transmitted in any one or combination of: one or more MAC CEs; one or more DCIs; a message associated with a measurement RS resource configuration; and a message associated with a network configuration change.

Example Embodiment D21. The method of any one of Example Embodiments D1 to D20, further comprising receiving, from the UE, a request for the NW configuration ID, wherein the NW configuration ID is transmitted to the UE based on and/or in response to and/or subsequent to the request for the NW configuration ID.

Example Embodiment D22. The method of any one of Example Embodiments D1 to D21, wherein the NW configuration ID is transmitted as a part of an NZP-CSI-RS-Resource information element.

Example Embodiment D23. The method of any one of Example Embodiments D1 to D22, further comprising: receiving, from the UE, a request for assistance information associated with the NW configuration ID, and transmitting, to the UE, the assistance information, and wherein the assistance information comprises: at least one of: an amount of time the NW configuration ID has been or is expected to be valid, a validity associated with at least one information element of the NW configuration ID; one or more statistics related to a use of the NW configuration ID; and an indication that the NW configuration ID is no longer valid.

Example Embodiment D24. The method of any one of Example Embodiments D1 to D23, wherein the network node comprises a gNodeB (gNB).

Example Embodiment D25. The method of any of the previous Example Embodiments, further comprising: obtaining user data; and forwarding the user data to a host or a user equipment.

Example Embodiment D26. A network node comprising processing circuitry configured to perform any of the methods of Example Embodiments D1 to D25.

Example Embodiment D27. A network node adapted to perform any of the methods of Example Embodiments D1 to D25.

Example Embodiment D28. A computer program comprising instructions which when executed on a computer perform any of the methods of Example Embodiments D1 to D25.

Example Embodiment D29. A computer program product comprising computer program, the computer program comprising instructions which when executed on a computer perform any of the methods of Example Embodiments D1 to D25.

Example Embodiment D30. A non-transitory computer readable medium storing instructions which when executed by a computer perform any of the methods of Example Embodiments D1 to D25.

### Group E Example Embodiments

Example Embodiment E1. A user equipment comprising: processing circuitry configured to perform any of the steps of any of the Group A and C Example Embodiments; and power supply circuitry configured to supply power to the processing circuitry.

Example Embodiment E2. A network node comprising: processing circuitry configured to perform any of the steps of any of the Group B and D Example Embodiments; power supply circuitry configured to supply power to the processing circuitry.

Example Embodiment E3. A user equipment (UE) comprising: an antenna configured to send and receive wireless signals; radio front-end circuitry connected to the antenna and to processing circuitry, and configured to condition signals communicated between the antenna and the processing circuitry; the processing circuitry being configured to perform any of the steps of any of the Group A and C Example Embodiments; an input interface connected to the processing circuitry and configured to allow input of information into the UE to be processed by the processing circuitry; an output interface connected to the processing circuitry and configured to output information from the UE that has been processed by the processing circuitry; and a battery connected to the processing circuitry and configured to supply power to the UE.

Example Embodiment E4. A host configured to operate in a communication system to provide an over-the-top (OTT) service, the host comprising: processing circuitry configured to provide user data; and a network interface configured to initiate transmission of the user data to a cellular network for transmission to a user equipment (UE), wherein the UE comprises a communication interface and processing circuitry, the communication interface and processing circuitry of the UE being configured to perform any of the steps of any of the Group A and C Example Embodiments to receive the user data from the host.

Example Embodiment E5. The host of the previous Example Embodiment, wherein the cellular network further includes a network node configured to communicate with the UE to transmit the user data to the UE from the host.

Example Embodiment E6. The host of the previous 2 Example Embodiments, wherein: the processing circuitry of the host is configured to execute a host application, thereby providing the user data; and the host application is configured to interact with a client application executing on the UE, the client application being associated with the host application.

Example Embodiment E7. A method implemented by a host operating in a communication system that further includes a network node and a user equipment (UE), the method comprising: providing user data for the UE; and initiating a transmission carrying the user data to the UE via a cellular network comprising the network node, wherein the UE performs any of the operations of any of the Group A embodiments to receive the user data from the host.

Example Embodiment E8. The method of the previous Example Embodiment, further comprising: at the host, executing a host application associated with a client application executing on the UE to receive the user data from the UE.

Example Embodiment E9. The method of the previous Example Embodiment, further comprising: at the host, transmitting input data to the client application executing on the UE, the input data being provided by executing the host application, wherein the user data is provided by the client application in response to the input data from the host application.

Example Embodiment E10. A host configured to operate in a communication system to provide an over-the-top (OTT) service, the host comprising: processing circuitry configured to provide user data; and a network interface configured to initiate transmission of the user data to a cellular network for transmission to a user equipment (UE), wherein the UE comprises a communication interface and processing circuitry, the communication interface and processing circuitry of the UE being configured to perform any of the steps of any of the Group A and C Example Embodiments to transmit the user data to the host.

Example Embodiment E11. The host of the previous Example Embodiment, wherein the cellular network further includes a network node configured to communicate with the UE to transmit the user data from the UE to the host.

Example Embodiment E12. The host of the previous 2 Example Embodiments, wherein: the processing circuitry of the host is configured to execute a host application, thereby providing the user data; and the host application is configured to interact with a client application executing on the UE, the client application being associated with the host application.

Example Embodiment E13. A method implemented by a host configured to operate in a communication system that further includes a network node and a user equipment (UE), the method comprising: at the host, receiving user data transmitted to the host via the network node by the UE, wherein the UE performs any of the steps of any of the Group A and C Example Embodiments to transmit the user data to the host.

Example Embodiment E14. The method of the previous Example Embodiment, further comprising: at the host, executing a host application associated with a client application executing on the UE to receive the user data from the UE.

Example Embodiment E15. The method of the previous Example Embodiment, further comprising: at the host, transmitting input data to the client application executing on the UE, the input data being provided by executing the host application, wherein the user data is provided by the client application in response to the input data from the host application.

Example Embodiment E16. A host configured to operate in a communication system to provide an over-the-top (OTT) service, the host comprising: processing circuitry configured to provide user data; and a network interface configured to initiate transmission of the user data to a network node in a cellular network for transmission to a user equipment (UE), the network node having a communication interface and processing circuitry, the processing circuitry of the network node configured to perform any of the operations of any of the Group B and D Example Embodiments to transmit the user data from the host to the UE.

Example Embodiment E17. The host of the previous Example Embodiment, wherein: the processing circuitry of the host is configured to execute a host application that provides the user data; and the UE comprises processing circuitry configured to execute a client application associated with the host application to receive the transmission of user data from the host.

Example Embodiment E18. A method implemented in a host configured to operate in a communication system that further includes a network node and a user equipment (UE), the method comprising: providing user data for the UE; and initiating a transmission carrying the user data to the UE via a cellular network comprising the network node, wherein the network node performs any of the operations of any of the Group B and D Example Embodiments to transmit the user data from the host to the UE.

Example Embodiment E19. The method of the previous Example Embodiment, further comprising, at the network node, transmitting the user data provided by the host for the UE.

Example Embodiment E20. The method of any of the previous 2 Example Embodiments, wherein the user data is provided at the host by executing a host application that interacts with a client application executing on the UE, the client application being associated with the host application.

Example Embodiment E21. A communication system configured to provide an over-the-top service, the communication system comprising: a host comprising: processing circuitry configured to provide user data for a user equipment (UE), the user data being associated with the over-the-top service; and a network interface configured to initiate transmission of the user data toward a cellular network node for transmission to the UE, the network node having a communication interface and processing circuitry, the processing circuitry of the network node configured to perform any of the operations of any of the Group B and D Example Embodiments to transmit the user data from the host to the UE.

Example Embodiment E22. The communication system of the previous Example Embodiment, further comprising: the network node; and/or the user equipment.

Example Embodiment E23. A host configured to operate in a communication system to provide an over-the-top (OTT) service, the host comprising: processing circuitry configured to initiate receipt of user data; and a network interface configured to receive the user data from a network node in a cellular network, the network node having a communication interface and processing circuitry, the processing circuitry of the network node configured to perform any of the operations of any of the Group B and D Example Embodiments to receive the user data from a user equipment (UE) for the host.

Example Embodiment E24. The host of the previous 2 Example Embodiments, wherein: the processing circuitry of the host is configured to execute a host application, thereby providing the user data; and the host application is configured to interact with a client application executing on the UE, the client application being associated with the host application.

Example Embodiment E25. The host of the any of the previous 2 Example Embodiments, wherein the initiating receipt of the user data comprises requesting the user data.

Example Embodiment E26. A method implemented by a host configured to operate in a communication system that further includes a network node and a user equipment (UE), the method comprising: at the host, initiating receipt of user data from the UE, the user data originating from a transmission which the network node has received from the UE, wherein the network node performs any of the steps of any of the Group B and D Example Embodiments to receive the user data from the UE for the host.

Example Embodiment E27. The method of the previous Example Embodiment, further comprising at the network node, transmitting the received user data to the host.

1. A method by a user equipment, UE, comprising:
receiving, from a network node, at least one network configuration identifier, NW configuration ID; and
based on the at least one NW configuration ID, predicting a channel quality for a transmission resource.

2.-18. (canceled)

19. A method by a network node comprising:
transmitting, to a user equipment, UE, at least one network configuration identifier, NW configuration ID, for predicting, by the UE, a channel quality for a transmission resource.

20. The method of claim 19, comprising receiving, from the UE, the predicted channel quality for the transmission resource.

21. The method of claim 19, comprising receiving from the UE, a request for the at least one NW configuration ID, wherein the at least one NW configuration ID is transmitted to the UE based on the request for the at least one NW configuration ID.

22. The method of claim 19, wherein the at least one NW configuration ID comprises or is associated with at least one of:
a network configuration;
a beam configuration;
a beam identifier;
a parameter of a configuration associated with beam management;
a set of precoders used by the network node;
a serving cell of the network node; and
a number of beams and/or a beamforming pattern of the network node.

23. The method of claim 22, wherein the beam identifier is associated with a precoder used by the network node.

24. The method of claim 19, wherein the transmission resource comprises at least one of:
a time resource,
a frequency resource,
a time-frequency resource,
a Channel State Information-Reference Signal resource,
a Tracking Reference Signal resource,
a Positioning Reference Signal resource, and
a Synchronization Signal Block resource.

25. The method of claim 19, comprising:
transmitting, to the UE, at least one signal in the transmission resource, and wherein the UE is configured to perform at least one measurement on the transmission resource during a first time period and to store data associated with the at least one measurement, and
wherein the data associated with the at least one measurement comprises at least one value associated with the at least one measurement performed during the first time period.

26. The method of claim 25, comprising configuring the UE to predict the channel quality for the transmission resource, and wherein configuring the UE to predict the channel quality for the transmission resource comprises configuring the UE to:
use the data associated with the at least one measurement performed during the first time period to build a machine-learning, ML, model for the at least one NW configuration ID; and
use the ML model to generate one or more ML model outputs that predict the channel quality for the transmission resource for a second time period.

27. The method of claim 26, comprising configuring the UE to build the ML after a minimum amount of data is obtained, the minimum amount of data comprising N number of data samples or N number of measurement values.

28. The method of claim 26, wherein the one or more ML model outputs comprise one or more values and/or characteristics indicating the channel quality of the transmission resource during the second time period.

29. The method of claim 19, comprising receiving, from the UE, a confidence level associated with the predicted channel quality for the transmission resource.

30. The method of claim 19, wherein:
each NW configuration ID comprises a plurality of information elements,
each of the plurality of information elements is associated with an element of a network configuration, and
one or more of the plurality of information elements is based on and/or indicative of at least one of the following:
deployment information comprising at least one of:
an antenna physical tilt;
an antenna physical direction; and/or
an antenna position;
hardware information comprising at least one of:
an antenna panel;
an antenna design; and/or
an impairment characteristic;
beamforming information indicating a beam and/or a transmission power.

31. The method of claim 30, wherein a first portion of the plurality of information elements is transmitted in a first signal, and wherein a second portion of the plurality of information elements is transmitted in a second signal.

32. The method of claim 19, wherein the at least one NW configuration ID is transmitted in one or more messages, the one or more messages comprising any one or combination of:
one or more cell-specific Radio Resource Control, RRC, messages;
one or more RRC messages that are sent to the UE during an access procedure; and
one or more RRC messages that is UE-specific and sent to the UE after the UE is connected to the network.

33. The method of claim 19, wherein the at least one NW configuration ID is transmitted in any one or combination of:
one or more Medium Access Control Control Elements, MAC CEs;
one or more Downlink Communication Informations, DCIs;
a message associated with a measurement reference signal resource configuration; and
a message associated with a network configuration change.

34. The method of claim 19, wherein the at least one NW configuration ID is transmitted as a part of an Non-Zero Power-Channel State Information-Reference Signal-Resource, NZP-CSI-RS-Resource, information element.

35. The method of claim 19, comprising:
receiving, from the UE, a request for assistance information associated with the at least one NW configuration ID, and
transmitting, to the UE, the assistance information, and
wherein the assistance information comprises at least one of:
an amount of time the at least one NW configuration ID has been or is expected to be valid,
a validity associated with at least one information element of the at least one NW configuration ID;
one or more statistics related to a use of the at least one NW configuration ID; and
an indication that the at least one NW configuration ID is no longer valid.

36. A user equipment adapted to:
receive, from a network node, at least one network configuration identifier, NW configuration ID; and
based on the at least one NW configuration ID, predict a channel quality for a transmission resource.

37. (canceled)

38. A network node adapted to:
transmit, to a user equipment, UE, at least one network configuration identifier, NW configuration ID, for predicting, by the UE, a channel quality for a transmission resource.

39. (canceled)
